(19) United States
(12) Patent Application Publication
(10) Pub. No.: US 2004/0104338 A1
(43) Pub. Date: Jun. 3, 2004

(54) Calibration and error correction method for an oscillating scanning device

(76) Inventors: Ralph W. Bennett, Tallahassee, FL (US); Robert W. Mayer, Tallahassee, FL (US); Harold F. Qualls, Tallahassee, FL (US); Steven F. Bellenot, Tallahassee, FL (US)

Correspondence Address: Pennington, Moore, Wilkinson, Bell & Dunbar, P.A., 215 S. Monroe Street, 2nd Floor, 32301, Post Office Box 10095, Tallahassee, FL, 32302-2095, US

(21) Appl. No.: 10/673,308

(22) Filed: Sep. 29, 2003

Related U.S. Application Data
(63) Continuation-in-part of application No. 09/960,508, filed on Sep. 24, 2001, now abandoned.

(51) Int. Cl. H01J 3/14; H01J 5/16

(52) U.S. Cl. 250/234

(57) ABSTRACT

Techniques for calibrating a laser scanner using a beam and camera which are swept in synchronization across a target object. A special calibration machine is disclosed. This machine mounts a completed scanner assembly and moves a target to collect camera output data from the scanner. The machine includes position sensing means which accurately determine the position of the target. The target position is then correlated to the camera output data for a variety of points. Curve-fitting techniques are then employed to create a mathematical function which converts the a given camera output datum to a distance from the scanner. The calibration machine is also used to create a table of correction factors which are used for different scanner mirror positions. The curve-fitting mathematical function, along with the table of error corrections, are then embedded in the software which converts the raw camera output data to computed points in three-dimensional space. The process does not require the development of complex optical equations.

### CROSS-REFERENCES TO RELATED APPLICATIONS

This patent application is a continuation-in-part of U.S. application Ser. No. 09/960,508, filed on Sep. 24, 2001. The same four inventors are named in this application and in U.S. application Ser. No. 09/960,508.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of optical scanning. More specifically, the invention comprises methods for calibrating a laser scanning device and methods for correcting errors present in the scanning data when the scanning device is in operation.

2. Description of the Related Art

Lasers have been used to measure distances for many years. The fact that they can very accurately measure such distances makes them ideal for scanning applications, where the laser is used to measure a set of distances in order to define the scanned object's shape. An example of one such device is disclosed in U.S. Pat. No. 5,414,268 to McGee (1995). The McGee device uses fifty-six fixed lasers to project points of coherent light on the object to be scanned. Half the lasers are positioned on one side of the object and half on the other. Twelve line scan cameras are mounted in the same plane as the lasers. These “look” for the points of coherent light on the scanned object. FIG. 5 of the McGee disclosure demonstrates the trigonometric principle by which a line scan camera can be used in conjunction with a coherent light source to measure distance. The '268 device can simultaneously measure the distance to 28 points on each side of the scanned object.

Mechanical means are used to move the object through the plane of the lasers and scanners. Thus, when the device is used in conjunction with means for data collection and analysis, an approximate surface model of the scanned object can be created.

While it does accomplish the desired result, the '268 device has several significant disadvantages. First, as discussed previously, it employs 56 lasers and 12 cameras. The expense of using this many lasers and cameras is considerable. Second, the device can only scan in one plane. Thus, mechanical actuation means are needed to move the object up and down through the scanning plane. The particular object disclosed in the '268 patent is a log. Log processing, like many industrial applications, involves objects moving at high speed along conveyor lines. The '268 device requires that the object be pulled off the moving line and subjected to a potentially lengthy scanning process. Given that log processing lines presently move at the rate of 300 to 400 feet per minute, this delay is a significant burden.

Some prior art devices are capable of scanning objects as they travel by at high speed. FIG. 1 illustrates one such device. Target object 10 is moving in the direction indicated. Laser 12 is fixed in position. It projects coherent beam 14 in a direction which is orthogonal to target object 10's travel. Cylindrical lens 16 is placed in the path of coherent beam 14. It spreads coherent beam 14 into coherent plane 18. Coherent plane 18 intersects target object 10, thereby creating projected arc 20.

FIG. 2 shows the same device from a different perspective. The key to the device's function is the fact that the orientation of camera 22 is angularly offset from the orientation of laser 12 by offset angle 24. Camera 22 is a video camera having a fairly wide field of view, and capable of accurately detecting the intersection of projected arc 20 on target object 10 in two dimensions (commonly denoted as X and Y).

FIG. 3 shows the view looking at target object 10 through the lens of camera 22. Target object 10 moves in the direction indicated. Projected arc 20 is seen upon the surface of target object 10. Because of offset angle 24, camera 22 is viewing projected arc 20 out of the plane of coherent plane 18. Thus, the intersection of coherent plane 18 upon target 10 is “seen” by camera 22 as projected arc 20. The laws of trigonometry dictate that the further a point on the surface of target 10 is away from laser 12, the further to the left in the field of view of camera 22 it will appear. Hence, point Y appears further left than point X. This results from the fact that point Y is further from laser 12 than point X.

If the position of camera 22 is accurately known with respect to laser 12, then the laws of trigonometry may be used to very accurately determine the distance from laser 12 to any point on projected arc 20. These principles are well understood in the prior art. As target object 10 is moved through coherent plane 18, camera 22 will view a whole series of projected arcs 20. These may be recorded and mathematically manipulated to create a surface model of target object 10.

Of course, those skilled in the art will realize that the surface model created is only of the side facing laser 12. A second laser and camera combination is needed to scan the far side of target object 10. Those skilled in the art will also realize that it is difficult to accurately record positions or the upper and lower extremity of target object 10 (because coherent light striking a target object at a small angle of incidence produces very little backscatter). Thus, it is common to have at least three scanners (laser and camera combinations) positioned around the object, separated by 120 degrees.

Computer hardware and software is typically used in conjunction with the ring of scanners to sample positional data at a fixed rate. The scanning system would also include a measurement device for finding the leading edge of target object 10 and for measuring its linear progress in the direction indicated by the arrow in FIG. 3. Thus, the system can compute the linear position along the length of target object 10 for each successive projected arc 20 which is sampled by camera 22. The distance from laser 12 to each point on projected arc 20 can be computed using straightforward trigonometry. These sets of surface points can then be employed to create a mathematical surface model of target object 10.

Target object 10 has been represented as a simple cylinder. However, it is important to realize that it can be any three-dimensional shape. The technique disclosed is not dependent upon the shape of the object being scanned. Different shapes will be used for target object 10 throughout this specification.

While the prior art method disclosed is functional, it does have several significant drawbacks. First, cylindrical lens 16 must spread coherent beam 14 into coherent plane 18. The result is that the intensity of coherent beam 14 is significantly diminished by virtue of its being spread across an arc.

The speed and accuracy of an optical scanner is significantly dependent on the signal to noise ratio produced by the scanning technique. Ideally, the laser impact on the target object should be much brighter than the ambient lighting. Interference filters are often used on camera 22 in order to increase the signal to noise ratio. An interference filter can be made by stacking a series of dielectric layers having varying indices of diffraction. The thicknesses selected for the alternating layers ideally has the effect of allowing light having a wavelength close to that of laser 12 to pass, while excluding other wavelengths. The result is an increase in the signal to noise ratio of the device.

However, the mechanical structure of such interference filters means that they only work well for light traveling in a direction which is perfectly perpendicular to the orientation of the filter (on-axis, with respect to the filter). The more off-axis the incoming light becomes, the more the wavelength of peak transmission shifts toward the blue end of the spectrum. As a result, interference filters work best with cameras having a narrow field of view. This results from the fact that a camera with a narrow field of view does not sample light which is significantly off the axis of the camera lens (and therefore off the axis of an interference filter placed within the camera lens assembly).

Returning to FIGS. 2 and 3, the user will observe that camera 22 must have a fairly wide field of view in order to encompass all of projected arc 20. The necessity of such a wide field of view means that the interference filters used in camera 22 lose much of their ability to discriminate light having the wavelength of laser 12 from unwanted ambient light. The signal to noise ratio available in the prior art device illustrated in FIGS. 1-3 is therefore limited due to the required wider band-pass filter and the spreading of the laser energy over a wide area.

Those skilled in the art will also realize that target object 10 may have a rough and irregular surface, further diffusing the laser light (This is especially true of target objects such as logs, which have a very rough external surface). The result is that camera 22 will often lose projected arc 20 within the surrounding ambient light. Thus, light-blocking shrouds are often needed, which are very cumbersome in a production line. If the shrouds are not used, then the entire working environment must often be made very dark. This is difficult and potentially dangerous for the persons working on the line.

In addition, the significant angular offset needed between camera 22 and laser 12 introduces mounting and stability concerns. If the two devices vibrate relative to each other, this will introduce an error in the scanned surface model of target object 10. This technique is often used in large production lines with very heavy machinery. Vibration is a significant concern.

Some prior art scanners solve this problem by projecting only a single beam of coherent light. This beam is swept across the face of the object. A camera with a relatively narrow field of view is swept across the face of the object in synchronization with the beam. Such a system is disclosed in U.S. Pat. No. 4,775,235 to Hecker et.al. (1988). The Hecker device uses relatively small mirror surfaces. Larger surfaces are not needed, since the Hecker device sweeps through a relatively narrow arc. If the Hecker device is substantially modified in order to allow a much larger scan arc, new problems are introduced. First, much larger reflective surfaces are needed. Second, those skilled in the art will know that image distortion will be present as the scanner approaches the extremes of the scan arc (This phenomenon will be disclosed in detail in the following). Finally, the use of large reflective surfaces introduces unpredictable distortion, owing to manufacturing tolerances. Thus, redesigning the Hecker device to cover a wide scan arc requires the application of new techniques.

### BRIEF SUMMARY OF THE INVENTION

The present invention comprises techniques for calibrating a laser scanner using a beam and camera which are swept in synchronization across a target object. A special calibration machine is disclosed. This machine mounts a completed scanner assembly and moves a target to collect camera output data from the scanner. The machine includes position sensing means which accurately determine the position of the target. The target position is then correlated to the camera output data for a variety of points. Curve-fitting techniques are then employed to create a mathematical function which converts the a given camera output datum to a distance from the scanner.

The calibration machine is also used to create a table of correction factors which are used for different scanner mirror positions. The curve-fitting mathematical function, along with the table of error corrections, are then embedded in the software which converts the raw camera output data to computed points in three-dimensional space. The process does not require the development of complex optical equations.

The illustrations assume that the target object will be moved past the scanning device, such as by an assembly line conveyor. By sweeping the scan up and down the surface of the target object and monitoring the target object's linear progress past the scanning device, the location of numerous points on the surface of the target object can be determined by the scanner. Conventional mathematical modeling techniques can then be used to develop a three-dimensional surface model of the target object. This surface model can then be used to drive a variety of subsequent operations, such as cutting, welding, shaping, etc.

It is important for the reader to realize that the same techniques can be employed by fixing the position of the target object and moving the scanning device relative thereto. Thus, the scope of the invention should not be limited to scanning operations on moving assembly lines.

### BRIEF SUMMARY OF THE SEVERAL VIEWS OF THE DRAWINGS

FIG. 1 is an isometric view, showing a typical prior art device.

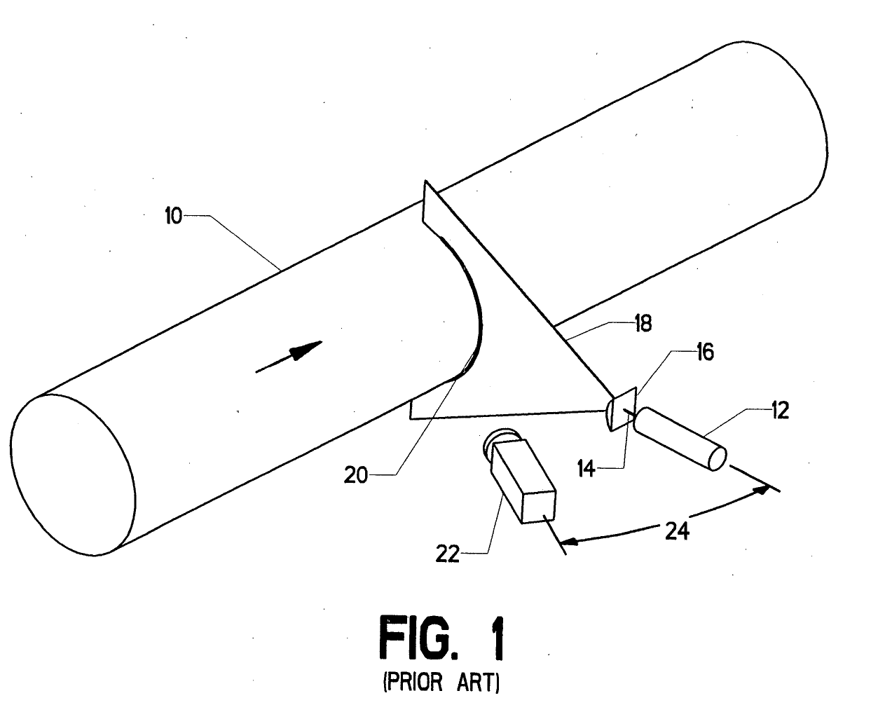

FIG. 2 is an isometric view, showing the same prior art device from a different angle.

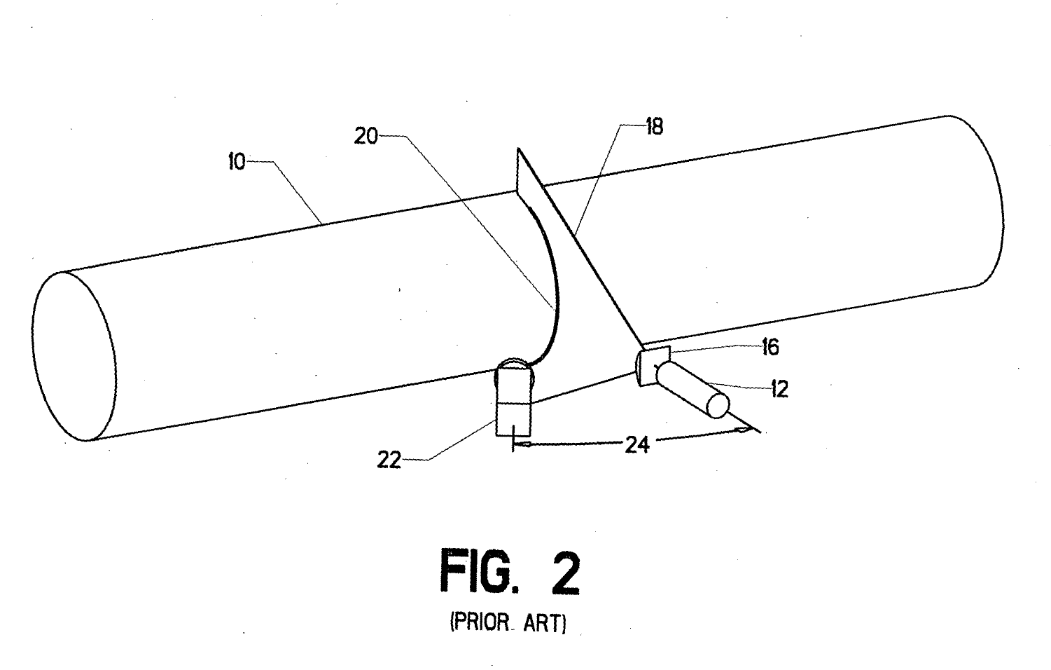

FIG. 3 is an elevation view, showing the view of the camera in the prior art device.

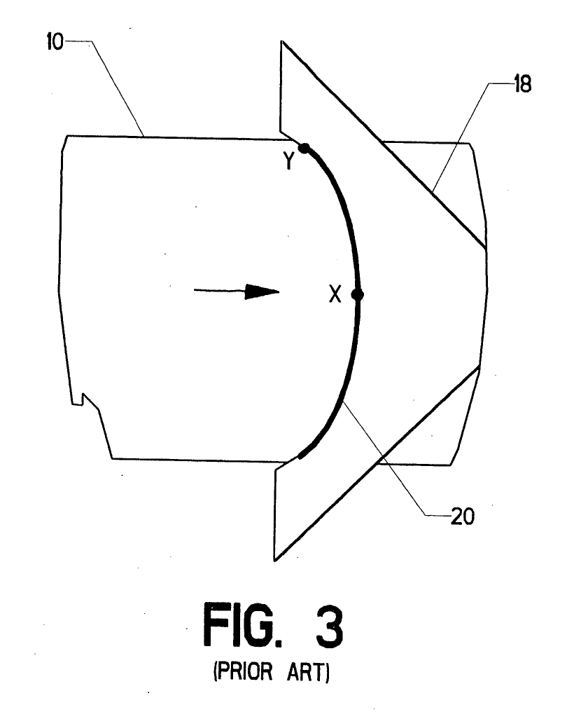

FIG. 4 is an isometric view, showing one embodiment of the proposed invention.

FIG. 5A is an isometric view, showing a more complete view of the proposed invention.

FIG. 5B is an elevation view, showing the view of the line scan camera.

FIG. 5C is an elevation view, showing a target object passing the scanning device.

FIG. 6 is an isometric view, showing a view of the proposed invention from the rear.

FIG. 7 is a plan view, illustrating the trigonometric principles of the proposed invention.

FIG. 8 is an isometric view, illustrating the preferred embodiment of the proposed invention

FIG. 9 is an isometric view, showing a more complete view of the embodiment seen in FIG. 8.

FIG. 10 is an isometric view, showing a view of the preferred embodiment from the rear.

FIG. 11 is a plan view, illustrating the trigonometric principles of the preferred embodiment.

FIG. 12 is a plan view, showing more detail of he scanning device shown in FIG. 11.

FIG. 13 is an isometric view, illustrating the operation of the preferred embodiment.

FIG. 14 is an isometric view, illustrating the operation of the preferred embodiment.

FIG. 15 is a plan view, illustrating the operation of the preferred embodiment.

FIG. 16 is a plan view, illustrating the operation of the preferred embodiment.

FIG. 17 is an isometric view, illustrating the trajectory of the laser and camera view when the common mirror is deflected fully downward.

FIG. 18 is an isometric view, illustrating some of the principles of optics.

FIG. 19 is an isometric view, illustrating some of the principles of optics.

FIG. 20 is an isometric hidden line view, showing the mounting of the scanner in a housing.

FIG. 21 is a perspective view, showing a calibration machine.

FIG. 22 is a perspective view, showing a scanner mounted on the calibration machine.

FIG. 23 is a perspective view, showing the calibration process.

FIG. 24 is a perspective view, showing the calibration process.

FIG. 25 is a perspective view, showing the calibration process.

FIG. 26 is a perspective view, showing the calibration process.

FIG. 26B is a graphical view, showing some trigonometry.

FIG. 27 is a graphical view, showing the curve-fitting process.

FIG. 28 is a graphical view, showing the error correction process.

### REFERENCE NUMERALS TN THE DRAWINGS

10 target object

12 laser

14 beam

16 cylindrical lens

18 coherent plane

20 projected arc

22 camera

24 offset angle

26 line scan camera

28 galvanometer

30 oscillating shaft

32 laser mirror

34 camera mirror

36 camera field of view

38 common mirror

40 near extreme distance

42 splitting mirror

44 projector mirror

46 receiver mirror

48 near impact point

50 far impact point

52 separation distance

54 first impact point

56 second impact point

58 target vector

60 width of view

62 sample distance

64 third impact point

66 beam origin point

68 scanning band

70 incident ray

72 reflected ray

74 plane of incidence

76 plane of reflection

78 incident ray projection

80 mirror surface

82 housing

84 galvanometer mount

86 mirror mount

88 lid

90 camera portal

92 laser portal

94 far extreme distance

96 calibration machine

98 chassis

100 scanner mount

102 carriage

104 target surface

106 guide rod

108 bearing

110 screw drive

112 screw receiver

114 drive motor

116 scanner assembly

118 impact point

120 horizontal distance

122 vertical distance

124 calculated beam length

126 data point

128 polynomial curve fit

### DETAILED DESCRIPTION OF THE INVENTION

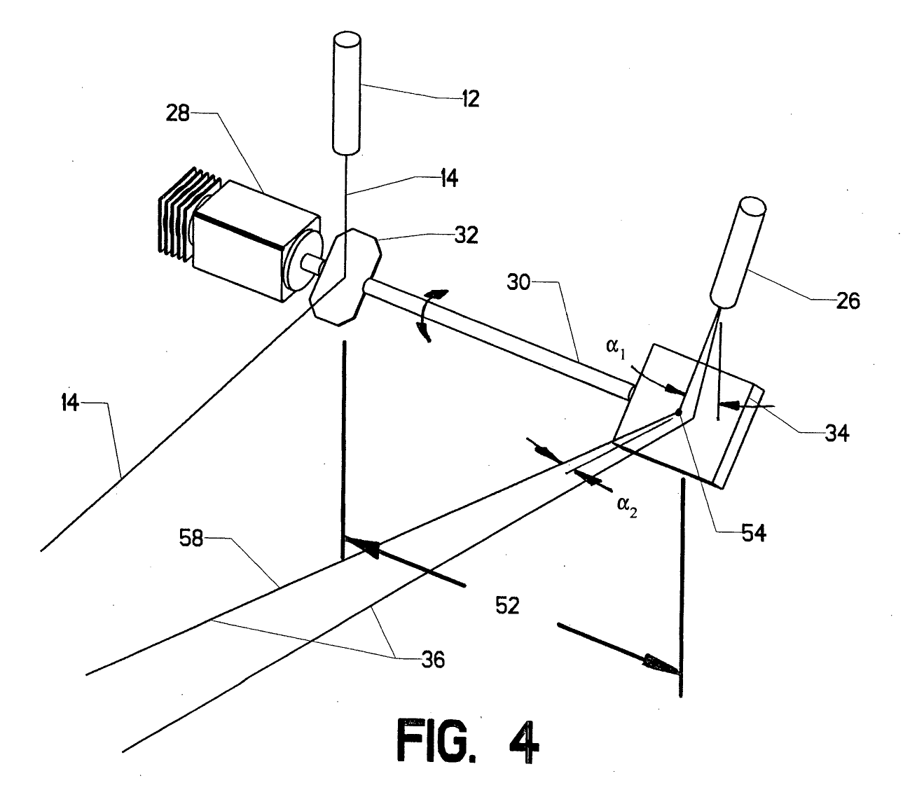

In order to understand the context in which the present invention operates, it is helpful to understand how a swept-beam optical scanner functions. FIG. 4 depicts one embodiment of a swept beam optical scanner. Galvanometer 28 has oscillating shaft 30 extending from one side as shown. Galvanometer 28 is typically an electrically-activated driving unit. It is biased to the neutral position shown. However, galvanometer 28 also has electromagnetic actuators which can cause oscillating shaft 30 to deflect +/−7.5 degrees in a rapid and controlled fashion, as indicated by the reciprocating arrow. The internal details of galvanometer 28 are not significant to the present invention. However, the oscillating motion is significant, irrespective of what device is used to create it.

Laser mirror 32 is fixedly attached to oscillating shaft 30. Laser 12 is positioned above laser mirror 32. It directs beam 14 onto laser mirror 32. Beam 14 is then reflected outward as shown. Camera mirror 34 is also fixedly attached to oscillating shaft 30. It is separated from laser mirror by separation distance 52.

Line scan camera 26 is positioned above camera mirror 34. The reader will observe that line scan camera 26 is tilted relative to laser 12. It points downward onto camera mirror 34, but the aforementioned tilt skews its field of view at an angle relative to the direction of beam 14. Camera field of view 36 is thereby put on an intersecting course with beam 14. The significance of this intersecting course will be explained shortly.

Although persons skilled in the art will understand the term “line scan camera,” a brief explanation may be helpful. The sensing element in most video cameras is comprised of an array of light sensitive cells, commonly called pixels. A typical video camera might have an array of 512 pixels by 512 pixels (X and Y), for a total of 262,144 pixels. The data produced by the camera is often a voltage level for each of these pixels—which corresponds to the light intensity upon that pixel. A line scan camera, in contrast, only has a single line of pixels. A line scan camera corresponding to the visual acuity of the 512×512 conventional camera would have only a single row of 512 pixels (X only) (The reader should note that much higher pixel densities are now in use).

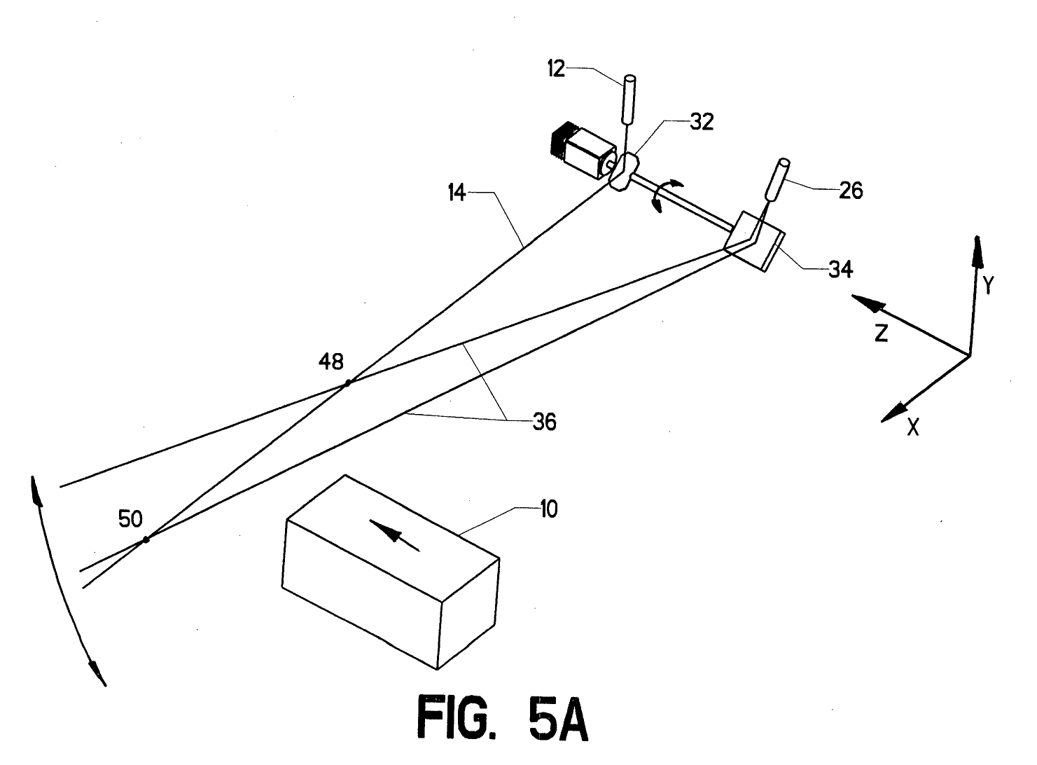

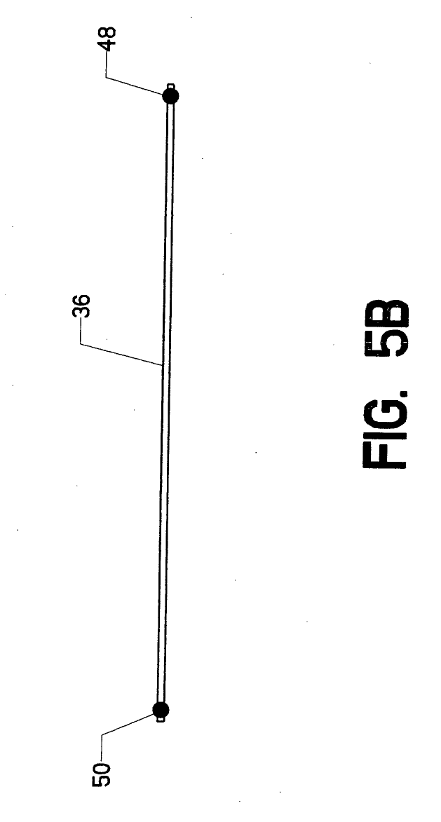

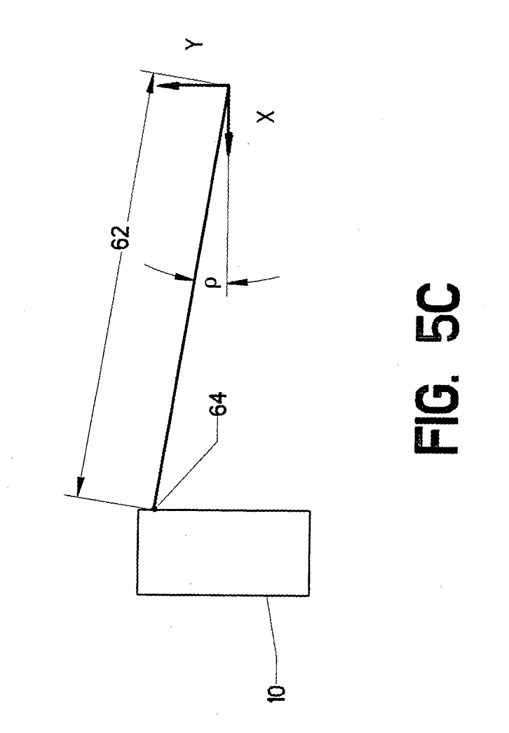

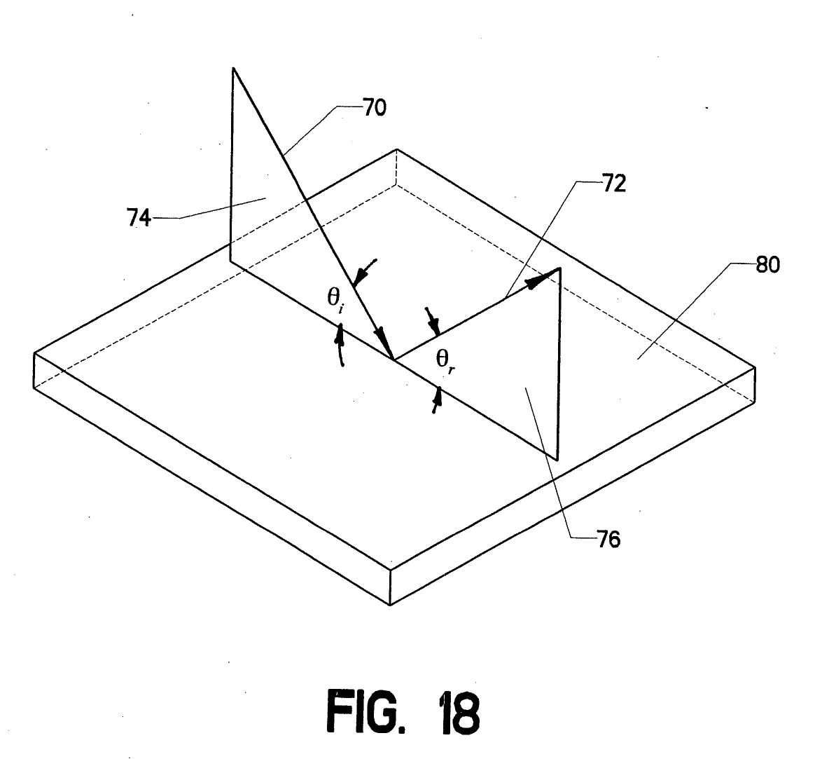

The reader will observe in FIG. 4 that beam 14 is reflected by laser mirror 32. Likewise, camera field of view 36 is reflected by camera mirror 34. Although the geometric principles of light reflection are well known to those skilled in the art, the following brief explanation may prove helpful in further understanding FIGS. 4 and 5. Turning now to FIG. 18, the reader will observe that incident ray 70 strikes mirror surface 80. In this example, incident ray 70 is traveling in a plane which is perpendicular to mirror surface 80, denoted as plane of incidence 74. Incident ray 70 strikes mirror surface 80 and is reflected as reflected ray 72. Since plane of incidence 74 is perpendicular to mirror surface 74, plane of reflection 76 is the same as plane of incidence 74. The angle of reflection, Or, will also be equal to the angle of incidence, θi.

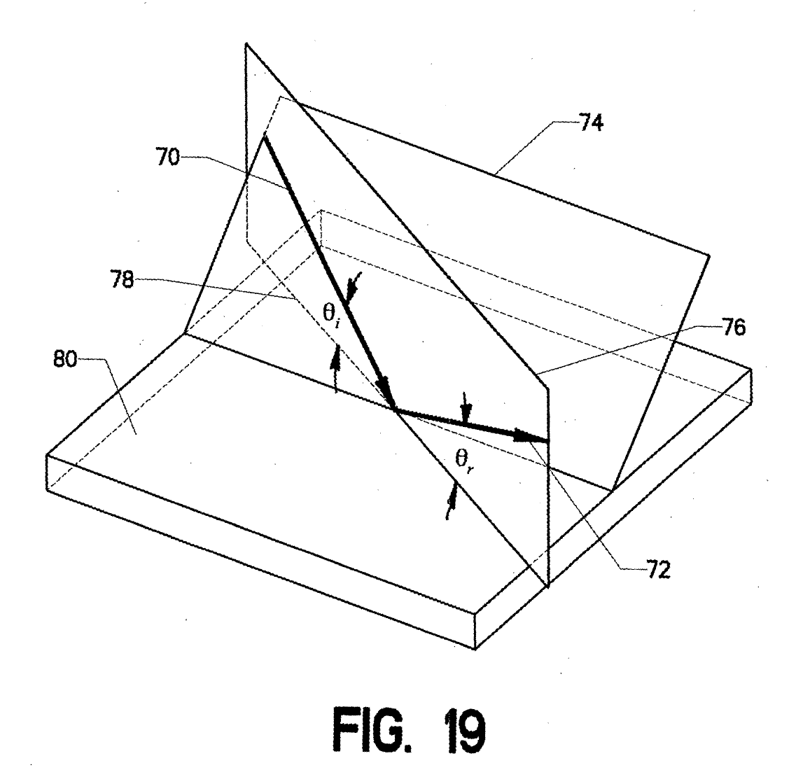

The situation is more complex when incident ray 70 is traveling in a plane which is not perpendicular to mirror surface 80. In FIG. 19, the reader will observe that plane of incidence 74 is not perpendicular to mirror surface 80. However, it is nevertheless very simple to determine the perpendicular projection of incident ray 70 upon mirror surface 80—denoted as incident ray projection 78. Incident ray 70 and incident ray projection 78 then define plane of reflection 76. The angle between incident ray 70 and incident ray projection 78 becomes the angle of incidence, θi. The angle of reflection, θr, must be equal to θi. Reflected ray 72 can then be determined. In this way, a general solution can be obtained for any ray striking a reflected surface at any angle.

Returning now to FIG. 4, the reader will observe that camera field of view 36 extends downward from line scan camera 26. The edges of camera field of view 36 diverge from one another at an angle of 6 degrees (for the particular line scan camera illustrated, which has a 6 degree field of view). Camera mirror 34 provides line scan camera 26 with a view out in the direction of travel of beam 14. The reader will observe that even though the path of light entering line scan camera 26 has been bent approximately 90 degrees by camera mirror 34, the divergence of the edges of camera field of view 36 continues.

The field of view of a conventional video camera (X and Y) is often graphically represented as a cone. The reader will therefore appreciate that the field of view of a line scan camera (X only) is appropriately represented by two diverging lines lying in a single plane, such as shown in FIG. 4.

FIG. 5A shows an expanded view of the same device depicted in FIG. 4. The reader will observe that beam 14 extends outward indefinitely. Being comprised of coherent light, beam 14 will continue on its path until it strikes a target object. A bright point of laser light will then be produced on the target object at this point of impact (“backscatter”). This impact point will be an intensely bright spot. Even if the target object is bathed in significant ambient light (even sunlight), the laser point of impact will be clearly visible.

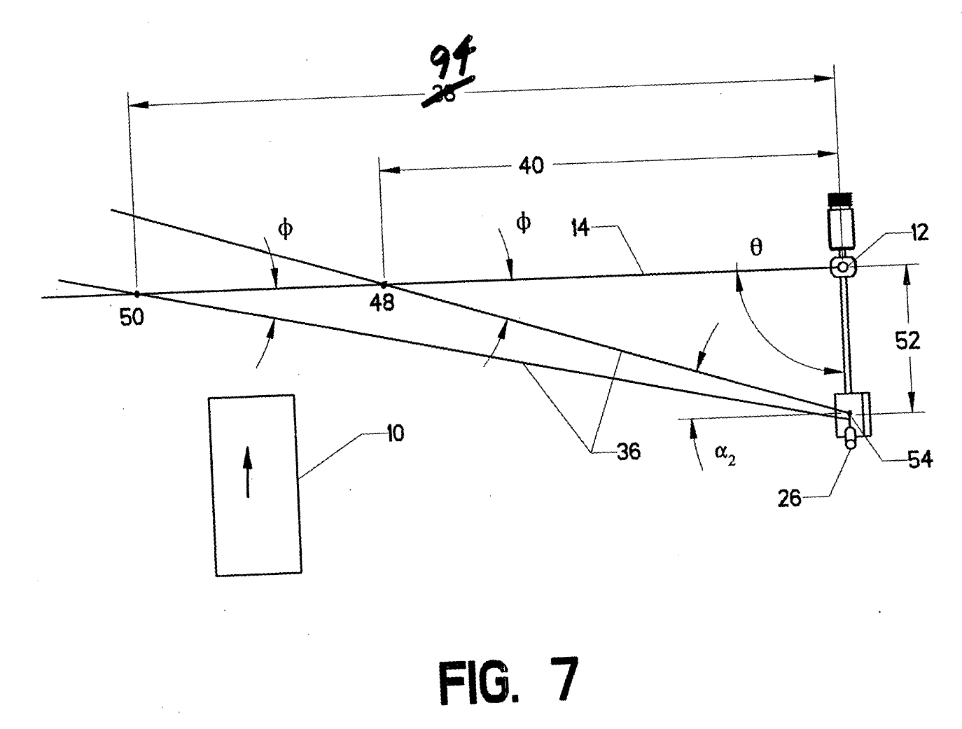

Owing to the aforementioned tilt of line scan camera 26, camera field of view 36 cuts across the path of beam 14. Turning briefly to FIG. 7, the significance of this feature will be explained. FIG. 7 is a plan view of the same device shown in FIGS. 4 and 5A. The reader will observe that the tilt of line scan camera 26 directs camera field of view 36 across the path of beam 14. It would be theoretically possible to eliminate the need for the angular tilt of line scan camera 26 by using a camera with a much wider field of view. However, as explained previously, the use of a narrow field of view is desirable because it allows the use of more efficient interference filters. It also reduces geometric distortion (the “fish-eye” effect) which must be taken into account in the distance calculations. Thus, the tilting of line scan camera 26 is a preferred feature of the embodiment shown.

Returning now to FIG. 5A, the trigonometric principles of the device will be explained. The device is capable of very accurately measuring distances within the range of near impact point 48 and far impact point 50. Although these two impact points will be used as examples, those skilled in the art will readily appreciate that the device can measure an infinite number of points in between impact points 48 and 50, limited only by the spatial resolution of the line scan camera.

If the near surface of the target object is located at near impact point 48, then beam 14 will produce a bright point of laser light at near impact point 48. This point corresponds to one extreme of camera field of view 36. FIG. 5B depicts the actual view of line scan camera 26. As explained previously, camera field of view 36 is a line of pixels (X only). The laser impact point will appear as near impact point 48, at the extreme right hand position of camera field of view 36. As depicted, the field of view of the line scan camera is wide, but not tall. It is therefore critical that the narrow height of the camera field of view intersects the path of beam 14. This goal is accomplished by fixing camera mirror 34 and laser mirror 32 to the same shaft. In this way the laser and the camera scan the target object together.

Returning to FIG. 5A, if the near surface of the target object is located at far impact point 50, then beam 14 will produce a bright point of laser light at far impact point 50. This point corresponds to the other extreme of camera field of view 36. In that case, the laser impact point in FIG. 5B will appear as far impact point 50, at the extreme left hand position of camera field of view 36. Intermediate positions of the target object will obviously correspond to intermediate positions of the bright point within camera field of view 36 on FIG. 5B.

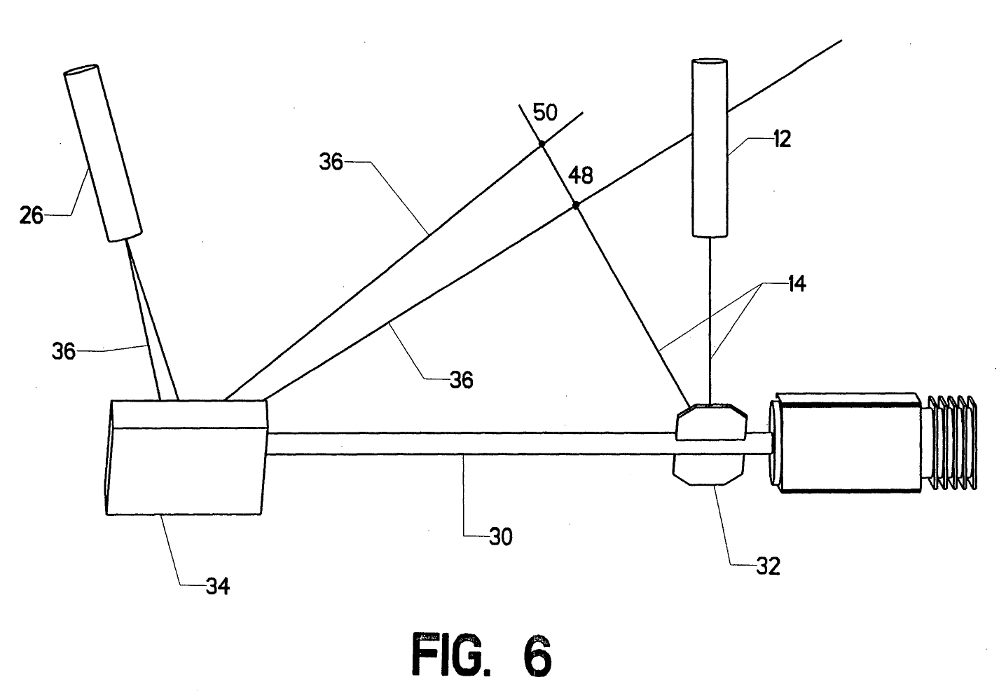

FIG. 6 shows a view from the rear of the scanning device. This view better illustrates how the position of the impact point upon the target object appears within the field of view of line scan camera 26. The further beam 14 travels before striking the target object, the further to the left the bright point will appear in camera field of view 36.

Those skilled in the art will readily appreciate that by knowing the position of the bright point within camera field of view 36 in FIG. 5B, straightforward trigonometry allows the computation of the distance from the scanning device to the target object. These trigonometric principles will be explained, with the initial reference being made to FIG. 4.

As an example, the principles will be explored for an impact point lying at the extreme right hand of camera field of view 36, which corresponds to the line denoted as target vector 58. It is important to realize that the same principles apply to any impact point lying within camera field of view 36.

Knowing the position of the laser impact point within camera field of view 36 allows the computation of the angle α₁. Since the distance between line scan camera 26 and camera mirror 34 is a known (depending on the position of oscillating shaft 30), the angle α₁ can be used to determine the position of first impact point 54 on camera mirror 34. This also allows the computation of the angle of incidence on camera mirror 34. Since the angle of incidence equals the angle of reflection, the angle α₂ can be calculated. Thus, the point of origin (first impact point 54) and the angular heading for target vector 58—which leads to the impact point on the target object—can be determined.

Continuing the same example, and turning now to FIG. 7, the reader will observe that beam 14 is directed outward in a direction perpendicular to oscillating shaft 30. This is represented in the view as the angle θ, which is constant at ninety degrees. Its point of impact on laser mirror 32 is always directly beneath laser 12. In the view shown, the point of origin for beam 14 will therefore be directly beneath laser 12. The point of origin for target vector 58, as explained previously, is first impact point 54. The angular heading of target vector 58 is known to be the angle α₂. It is then a matter of simple trigonometry to determine the value for the angle φ. Separation distance 52 between the point of origin for beam 14 and first impact point 54 can be calculated, since laser 12 is fixed in position and first impact point 54 has been previously calculated. Having determined the value for separation distance 52 and the angle φ, the distance to the impact point on the target object can be determined. Continuing the present example shown in FIG. 4, the impact point on the target object can be found by finding the intersection of target vector 58 and beam 14. Returning to FIG. 7, the intersection will be near impact point 48. The distance to that point will then be near extreme distance 40.

The same process can be employed to calculate the distance to any impact point between near impact point 48 and far impact point 50. It is this calculation of distance which comprises a scanner's critical function. The scanner is essentially a very accurate range finder.

Numerous computations are obviously required to determine the distance to the target object. This task is performed by monitoring the output of line scan camera 26 with a digital computer. Returning briefly to FIG. 5B, the user will appreciate that the position of the bright point along camera field of view 36 will correspond to digital data output. The computer scans this output to update the position of the bright point and compute the distance to the target object.

Returning now to FIG. 4, the function of galvanometer 28 will be explained in greater detail. Galvanometer 28 drives oscillating shaft 30 through periodic oscillations of +/−7.5 degrees. These oscillations are performed at a regulated rate, such as 60 Hz. Since laser mirror 32 and camera mirror 34 are attached to oscillating shaft 30, they oscillate in synchronization. Thus, laser mirror 32 and camera mirror 34 both oscillate through arcs of +/−7.5 degrees. The result is that beam 14 and camera field of view 36 oscillate through arcs of +/−15 degrees (The fact that the angle of reflection must be equal to the angle of incidence means that when the mirror moves −7.5 degrees, the reflected rays must move −15 degrees).

Turning now to FIG. 5A, the reader will observe that the oscillation of oscillating shaft means that beam 14 and the plane of camera field of view 36 move up and down in synchronization (as shown by the reciprocating arrow). This vertical oscillation means that the scanning device actually measures a series of impact points along a vertical line on the near surface of the target object. Target object 10 is typically moved into the path of beam 14, in the direction indicated. Its forward motion is continued as the oscillation of oscillating shaft 30 is continued. Thus, the scanning device is “walking” the beam up and down the near surface of the advancing target object 10. The digital computer is used to take regular samples and compute the distance to each sampled point.

Turning to FIG. 5C, the digital computer can also be used to monitor the position of oscillating shaft 30, denoted as the angle p. In this view the origin of the coordinate system is placed on the centerline of oscillating shaft 30 (oscillating shaft 30, the two mirrors, and the galvanometer are not shown for visual simplicity). Knowing sample distance 62 to sample impact point 64, as well as the angle p, allows the computation of sample impact point 64's position in terms of the X and Y coordinates shown in FIG. 5C.

Another sensor can be employed to accurately monitor the linear progress of target object 10 as it proceeds past the scanning device. Turning back to FIG. 5A, this additional sensory input allows the computer to determine the location of a particular impact point in the Z direction. The location of a whole series of points on the near surface of target object 10 can therefore be determined in X, Y, and Z coordinates. Mathematical modeling techniques can then be employed to create a detailed surface model of the near surface of target object 10 from the sample points. It is assumed that target object 10 is moving in a strictly linear fashion, such as on a conveyor belt. However, as explained previously, the same principles can be used where target object 10 remains fixed and the scanning device is moved in a controlled fashion.

Of course, just as for prior art scanners, the embodiment disclosed can only map the portion of target object 10 that it “sees.” It is difficult for the scanning device to sample more than 120 degrees around the circumference of a target object. Thus, a ring of three or more scanning devices would typically be employed to map the target object on all sides.

As stated previously, beam 14 and camera field of view 36 move in synchronization. This feature means that beam 14 does not need to be spread by a cylindrical lens or other means. The intensity of its impact upon target object 10 is therefore not reduced. The synchronized scanning also allows the use of a line scan camera with a relatively narrow field of view. This means that highly efficient interference filters can be used to attenuate unwanted ambient light. The result is that the scanner shown in FIG. 5A can achieve a desirable signal to noise ratio. It is therefore significantly less prone to errors induced by ambient light.

It is important to realize that computation speed is critical in many scanning operations. The target object must be scanned and mapped while it is moving at line speed. As soon as the target object has been accurately mapped, the map is used to drive other machinery which cuts, welds, or shapes the object (among many other possibilities). Thus, mathematical operations needed to convert the raw data from the line scan camera to positional data are time sensitive. The present invention allows very fast computations, as will be explained shortly.

First, however, a more detailed and realistic scanner will be described. Returning briefly to FIG. 4, those skilled in the art will realize that separation distance 52 is critical to the accuracy of the device. Increasing the value for separation distance 52 increases the parallax effect seen at line scan camera 26. This phenomenon is particularly apparent in FIGS. 6 and 7. The larger the value for separation distance 52, the larger the variation of the laser impact point within camera field of view 36 for a given change in distance from the scanning device to the laser impact point. Unfortunately, however, it is impractical to greatly increase separation distance 52 in the embodiment shown. Looking particularly at FIG. 6, the reader will observe that oscillating shaft 30 is long and relatively slender. Laser mirror 32 and camera mirror 34 represent significant oscillating masses. If high speed scanning is desired, it may be necessary to rotate oscillating shaft 30 at a rate of 100 Hz or more. This results in significant vibrational energy.

Those skilled in the art will realize that asymmetric forces will tend to bend and flex oscillating shaft 30 at the higher frequencies. Additional journal bearings can be used to stabilize the assembly, but the mechanical forces and resulting vibration will significantly erode the accuracy of the device. In addition, the energy requirements for driving the device increase significantly as oscillating shaft 30 grows longer. Accordingly, it is highly desirable to obtain an increased parallax effect at line scan camera 26 without the need for lengthening oscillating shaft 30.

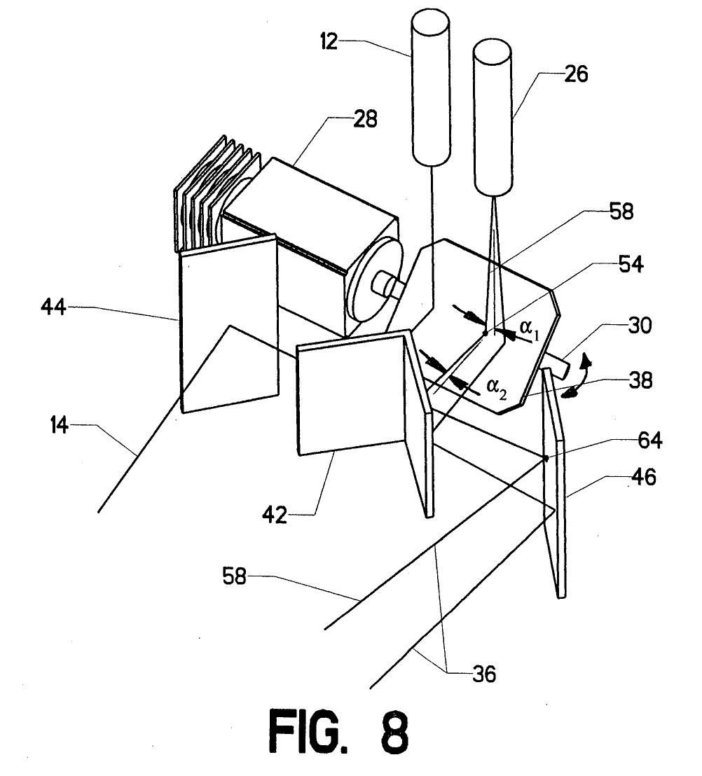

FIG. 8 depicts a refined scanner which solves this concern. Galvanometer 28 is identical to the one disclosed in FIG. 4. However, oscillating shaft 30 has been significantly shortened. A single common mirror 38 is attached to oscillating shaft 30. Laser 12 and line scan camera 26 are placed close together, directly above common mirror 38. The reader will also observe that line scan camera 26 is no longer tilted relative to laser 12.

The distance between laser 12 and line scan camera 26 in this case is insufficient to obtain the desired parallax effect and desired scanning accuracy. Another technique is therefore employed to effectively increase this distance. As beam 14 and camera field of view 36 are reflected away from common mirror 38, they encounter splitting mirror 42. Beam 14 is reflected to the left, and camera field of view 36 is reflected to the right. Beam 14 is then reflected again out toward the target object by projector mirror 44. Likewise, camera field of view 36 is reflected out toward the target object by receiver mirror 46. The particular line scan camera 26 has a 6 degree field of view—the same field of view as the line scan camera disclosed in FIGS. 4-7.

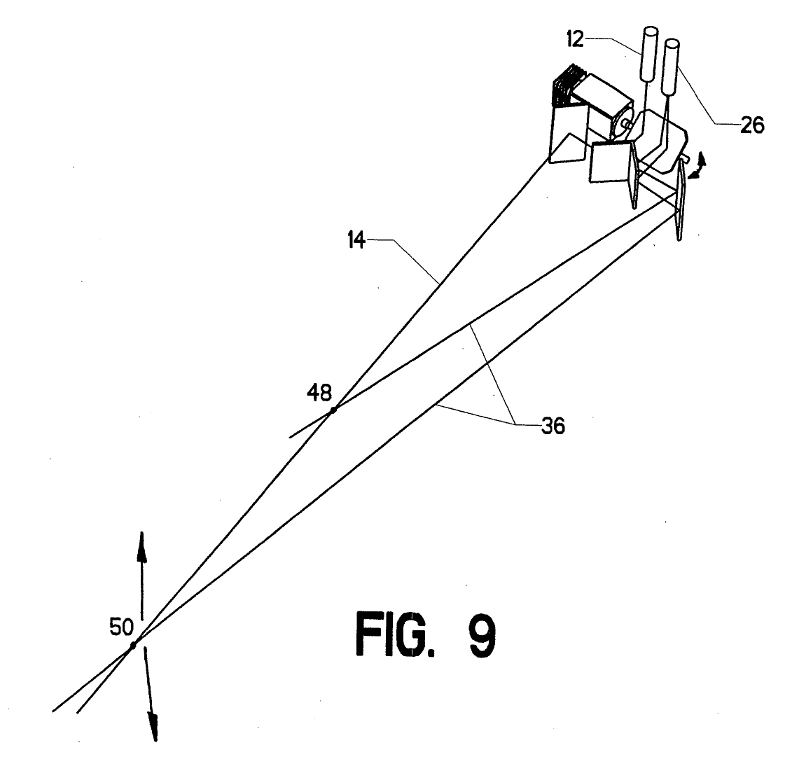

FIG. 9 shows a larger view of the same apparatus. Beam 14 is projected across the planar camera field of view 36. Just as in FIG. 5A, the range in which distances may be measured is denoted by near impact point 48 and far impact point 50. The operation of the device is very similar to the first embodiment disclosed in FIGS. 4 through 7. Oscillating shaft 30 moves through an arc of +/−7.5 degrees, as shown by the reciprocating arrow. This allows the device to sample many points along the near surface of the target object.

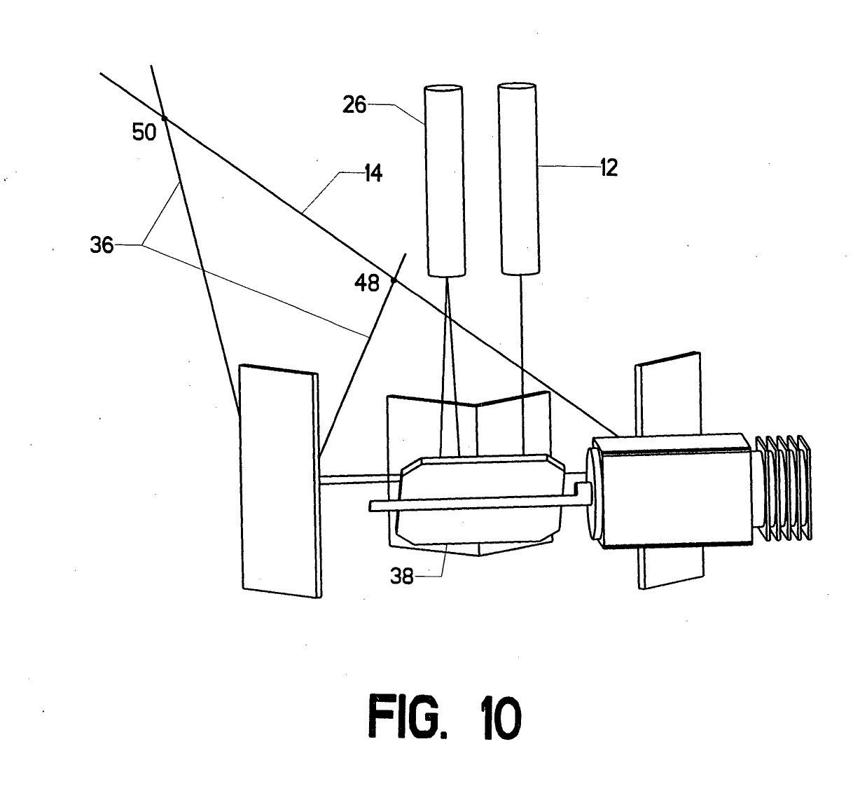

FIG. 10 shows a rear view of this version. The reader will in this view readily observe how beam 14 cuts across the planar camera field of view 36. Again, this view better illustrates how the position of the impact point upon the target object appears within the field of view of line scan camera 26. The further beam 14 travels before striking the target object, the further to the left the bright point will appear in camera field of view 36. Thus, far impact point 50 appears further to the left than near impact point 48.

Just like in the version described in FIGS. 4 through 7, calculating the distance to the impact point in the preferred embodiment is a matter of trigonometry. However, as more mirrors and reflections are involved, one can easily appreciate that the trigonometry will be more complex. Turning back to FIG. 8, another example will be employed to step through the computation process. Assume that the bright impact point of the laser on the target object appears at the extreme right hand of camera field of view 36. This will correspond to the extreme labeled as target vector 58 in the view. The reader will observe that target vector 58 has foul portions: (1) the portion from line scan camera 26 to common mirror 38; (2) the portion from common mirror 38 to splitting mirror 42; (3) the portion from splitting mirror 42 to receiver mirror 46; and (4) the portion from receiver mirror 46 out to the target object. In order to determine the location in space for the impact point upon the target object, a step-wise process must be employed.

The angle α₁ is known from the position of the bright point observed by line scan camera 26. The distance between line scan camera 26 and common mirror 38 is also known (for a given position of oscillating shaft 30). First impact point 54 may therefore be calculated. This point becomes the point of origin for the second leg of target vector 58. Since the angle of incidence equals the angle of reflection for common mirror 38, the angular heading of this second leg can also be calculated. This is denoted as the angle α₂.

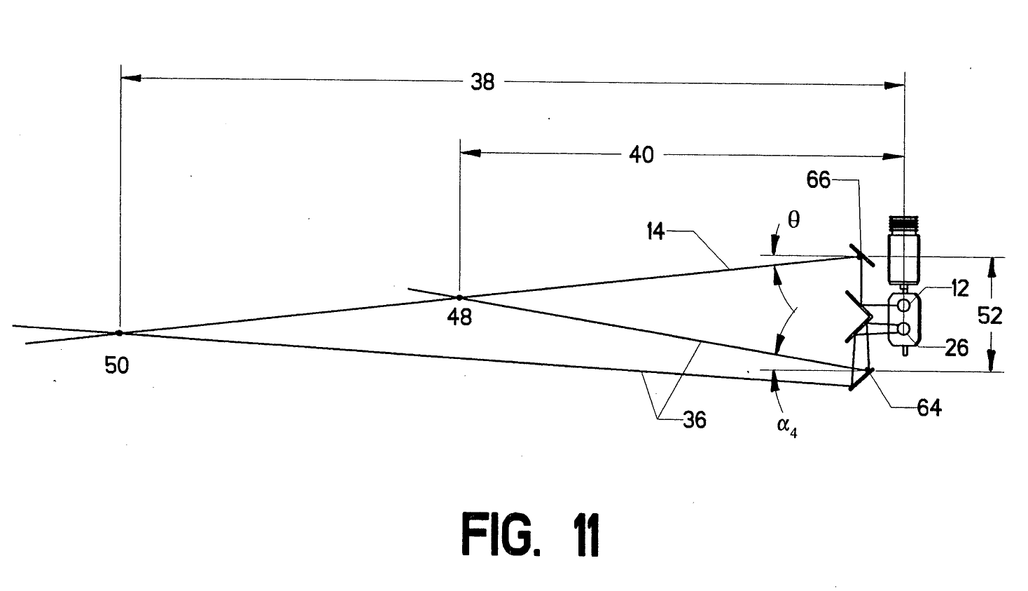

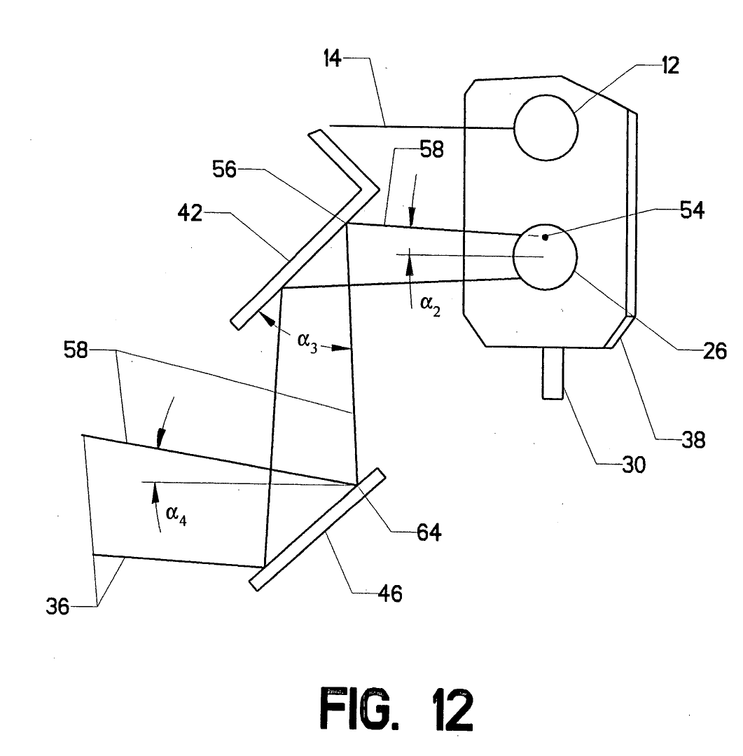

FIG. 8 shows oscillating shaft 30 in its neutral position; i.e., at an angle of 45 degrees with respect to beam 14 coming out of laser 12. This is a convenient position for illustration, because all of the trigonometry calculations can be performed in the plane of the plan view (realizing that when oscillating shaft 30 moves off the neutral position, both beam 14 and camera field of view 36 are projected out of the plane of the plan view). Such a plan view is shown in FIG. 11. A close-up of the device is shown in FIG. 12.

Splitting mirror 42 and receiver mirror 46 are fixed in position with respect to each other and with respect to common mirror 38 (for a given position of oscillating shaft 30). Knowing first impact point 54 and the angle α₂ therefore allows the calculation of second impact point 56. This then becomes the point of origin for the third portion of target vector 58. Again using the optical law that the angle of incidence equals the angle of reflection allows the computation of the angle α₃. This, in turn, allows the determination of third impact point 64. Applying the same optical law allows the computation of the angle α₄.

Thus, the point of origin and angular heading for the final portion of target vector 58 can be determined. This information is then used to find the intersection point of this portion with the path of beam 14. Turning back to FIG. 11, this intersection point will be near impact point 48. The distance from the scanning device to this impact point will correspond to near extreme distance 40. Again, it is important to realize that the same process can be used to solve for the distance of a point lying anywhere within camera field of view 36.

The angular computations illustrated in FIG. 12 are not overly complex, since beam 14 and camera field of view 36 both lie within the plan view when oscillating shaft 30 is in the neutral position. Of course, as explained previously, oscillating shaft 30 continuously moves through an arc of +/−7.5 degrees. This oscillating is required to “walk” the range finding function up and down the side of the target object. The oscillation is graphically depicted by the arrows in FIG. 9. Just like in the example illustrated in FIG. 5C, the fact that beam 14 and camera field of view 36 “walk” up and down the side of the target object allows the scanning device to measure the distance to a whole series of impact points within that vertical plane. Like in FIG. 5A, the target object is moved linearly past the scanning device, which allows scanning in a whole series of vertical planes. This data set can then be used to mathematically create a three dimensional surface model of the target object. However, it is important to realize that the oscillation adds another layer of complexity to the trigonometric calculations.

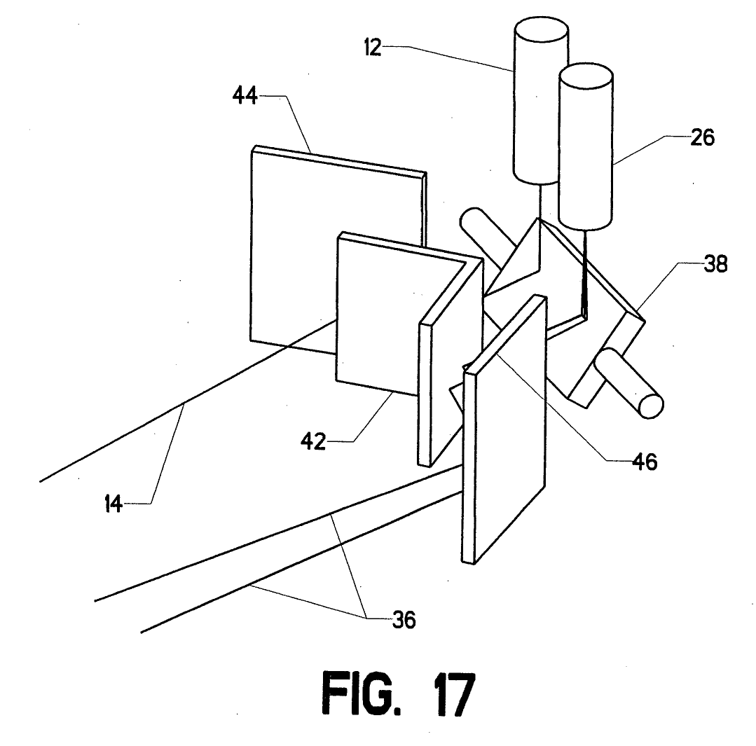

FIG. 17 shows oscillating shaft 30 and common mirror 38 in the −7.5 degree position (the galvanometer has not been shown in order to simplify the view). The reader will readily observe that beam 14 and camera field of view 36 are projected downward. While this fact does make the previously-explained calculations considerably more complex, they may nonetheless be solved using the same optical law that the angle of incidence equals the angle of reflection. It is therefore possible to solve for the vector leading to the impact point on the target object for any position of the galvanometer.

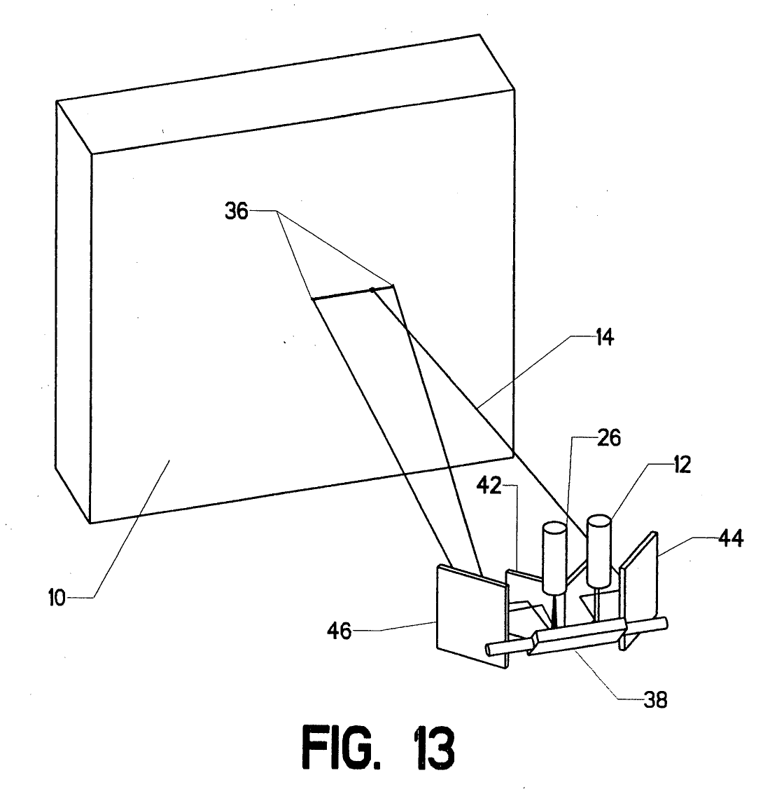

However, an additional layer of complexity should be addressed in order to facilitate a complete understanding of the device's operation. FIG. 13 shows a simplified representation of the scanning device projecting beam 14 onto the near surface of target object 10 (Once again, although target object 10 is shown as being geometrically simple, it could be any three-dimensional shape). Common mirror 38 is shown in the neutral position (which results in beam 14 and camera field of view 36 being projected straight out toward the target). If common mirror 38 is rotated in the negative direction, the projection of camera field of view 36 on target object 10 will travel downward. The projection will in fact continue traveling downward until common mirror 38 reaches its maximum negative deflection (−7.5 degrees).

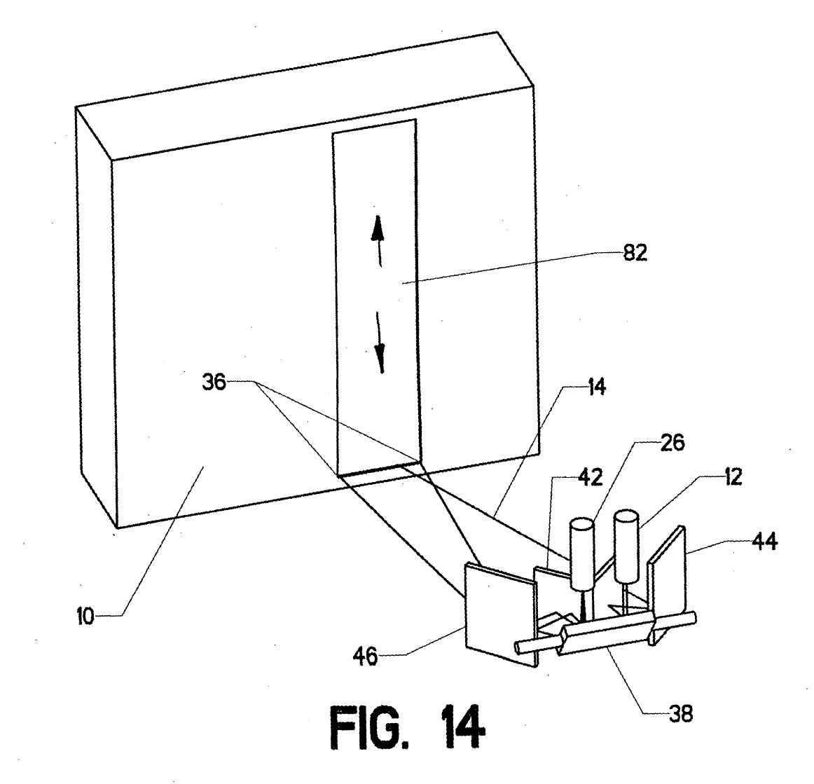

FIG. 14 shows common mirror 38 at the point of maximum negative deflection. The reader will note that beam 14 and the plane of camera field of view 36 have moved as far down on target object 10 as they can go. If common mirror 38 is oscillated through its full range of motion, camera field of view 36 and beam 14 will move up and down on target object 10, as shown by the reciprocating arrow. The result will be the creation of sweep area 82.

Those skilled in the art will realize that the vertical boundaries of sweep area 82 are not vertical lines. Instead, sweep area 82 has a slight hour-glass shape. This results from the fact that the projection of camera field of view 36 on target object 10 is wider at the +7.5 degree and −7.5 degree positions of common mirror 38 than it is for the neutral position. The explanation for this phenomenon is simple: The distance from the scanning device to the target object is shortest in the neutral position, since both beam 14 and camera field of view 36 strike the target object perpendicularly. As common mirror 38 is moved off the neutral position, the distance to the point of impact on the target object increases (graphically visible in comparing FIGS. 13 and 14).

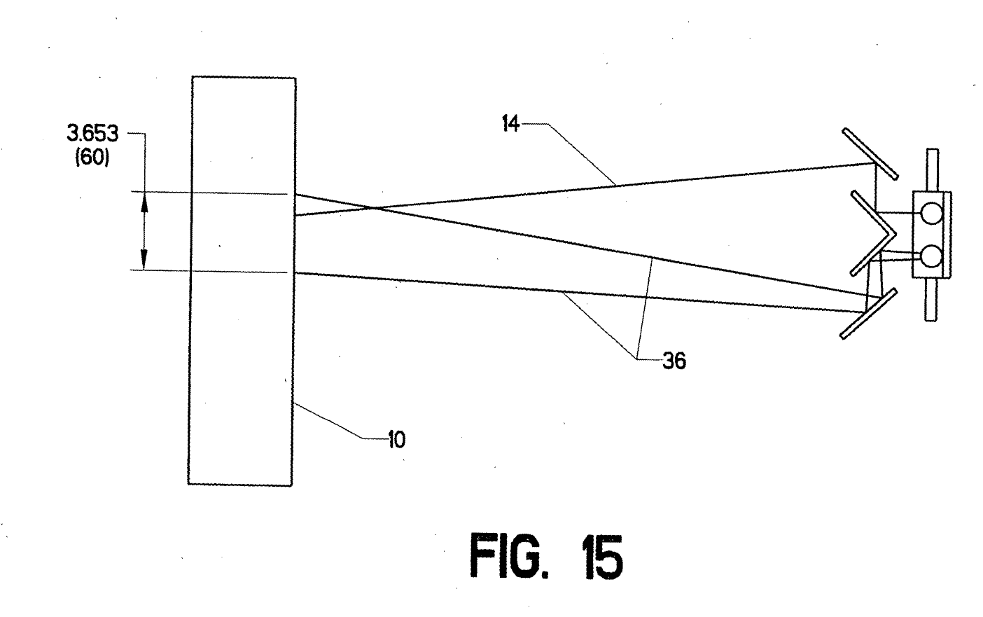

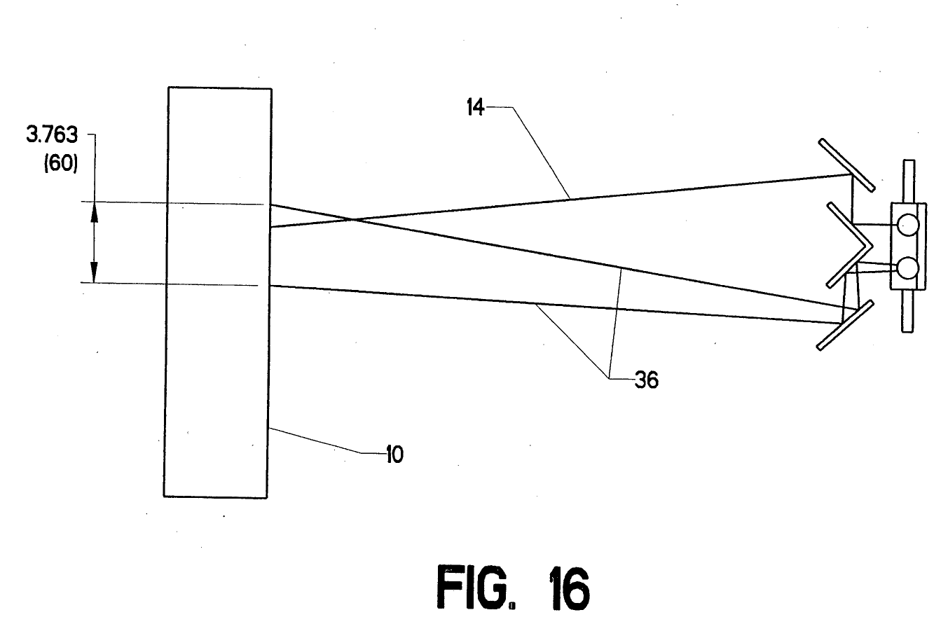

FIGs. 15 and 16 further illustrate this principle. FIG. 15 shows common mirror 38 in the neutral position. The reader will observe that beam 14 and camera field of view 36 fall upon target object 10. Width of view 60 indicates the width of camera field of view 36 at the point where it falls upon target object 10. For this particular line scan camera, width of view 60 equals 3.653 inches.

FIG. 16 shows common mirror 38 in the −7.5 degree position. Target object 10 remains in the same position. The reader will observe that width of view 60 is now equal to 3.763 inches, thus proving that the width of the projected field of view increases as common mirror 38 is moved away from the neutral position. It is important to realize that the numbers themselves are only important in the sense that they prove the concept of the hour-glass shaped scanning band 68.

This phenomenon is sometimes known as “pin-cushioning.” It is typical of the geometric distortions which must be accounted for in designing a scanning device. The computations performed must account for the hour-glass shape in order to achieve maximum accuracy. Take, as an example, a target object having a flat planar surface facing the scanning device. Target object 10 shown in FIGS. 13 and 14 does, in fact, have a flat planar surface facing the scanning device. The computations must account for the fact that the distance from the scanning device to the impact point on the target object is greater in FIG. 14 than in FIG. 13, even though a perfectly flat surface is being scanned. It is simple to account for this factor by using a polar coordinate system centered on oscillating shaft 30. If such a coordinate system is employed, the coordinates of any impact point on the target object can be expressed in terms of a distance and an angular position with respect to oscillating shaft 30. The Z coordinate (as referenced in FIG. 5A) is then obtained by measuring the linear progress of target object 10 past the scanner.

It is possible to write a series of trigonometric equations that solves for the position of any target impact point given the inputs of: (1) the position of oscillating shaft 30; (2) the position of the impact point on the target object within camera field of view 36; and (3) the linear position of the target object as it progresses past the scanner. One really only needs to understand the optical principle that the angle of incidence equals the angle of reflection. However, while these principles are important to a thorough understanding of the physics of the device, one seeking to use the device need not understand them.

Instead, the range finding function of the device can be implemented via experimental calibration. The calibration starts by setting and locking the position of oscillating shaft 30. A target object is then placed within camera field of view 36. The distance from a reference point on the scanning device (such as the centerline of oscillating shaft 30) to the impact point on the target object is then mechanically measured and recorded. The position of the impact point within the field of view of the line scan camera is also carefully measured and recorded. These two values can then be projected as an X-Y plot, with one value on the X axis and the other value on the Y axis. A whole series of such measurements can be made and recorded for different distances. A polynomial can then be fitted through the resulting data, thereby providing a mathematical expression which solves for target distance on the basis of the position of the impact point within the field of view of the line scan camera.

An additional series of measurements can be taken for different angular positions of oscillating shaft 30. A polynomial can then be created for each angular position. These polynomials are then stored in a digital computer.

The set of polynomials can be used to compute a distance to the impact point for a given position of the impact point within the field of view of the line scan camera and a given position of oscillating shaft 30. It is even possible to create a single curve-fitting polynomial which works for all positions of oscillating shaft 30. Thus, given the inputs of the position of oscillating shaft and the position of the impact point within the field of view of the line scan camera, the single polynomial can be used to compute the distance from the scanning device to that impact point. While this calibration process sounds unduly complex, those skilled in the art will readily appreciate that it is easily automated using computer software. And, once the geometry of the scanning device is set by the initial design, the calibration need only be performed once.

In fact, the calibration approach can produce far greater accuracy then simply implementing a set of optical equations. This is true because the optical equations must assume a “perfect world” of flat mirrors, rigid interlocking of the components, highly accurate mirror shaft position sensing, etc. While the use of optical equations can theoretically lead to a very accurate scanner, this is seldom the case.

Imagine a production line producing 100 scanners such as illustrated in FIG. 14. The same optical equations will be used to convert the line scan camera data into positional data for each of the scanners. Yet manufacturing variations will, of course, exist. The desired large sweep arc requires the use of fairly large mirror surfaces. Many of the mirrors will be rippled and warped. Many will be imperfectly mounted. A very slight variation in the angular position of a mirror is substantially amplified over the distance to the target (just as slightly moving a rifle will cause a projectile fired from that rifle to move dramatically). Many other manufacturing variations will be present (some of which may be noticed and some of which may not). Thus, the “calibration” approach is preferable.

The present invention comprises a process for manipulating the data from a scanner without having to derive (and depend upon) complex optical equations. It produces a set of mathematical functions which are specific to a particular scanner. It thereby encompasses all the manufacturing variations, including those which are unknown or poorly understood.

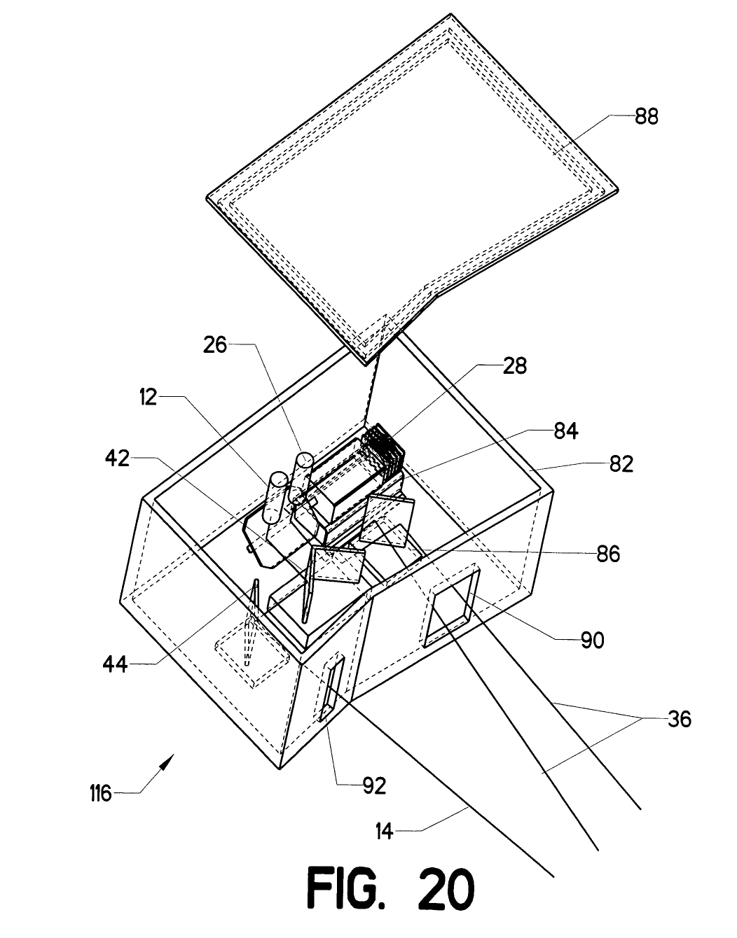

FIG. 20 depicts scanner assembly 116. It includes the folded-path scanning hardware discussed previously, but placed within housing 82. Suitable attachment hardware is needed, such as galvanometer mount 82 and several mirror mounts 86. Lid 88 is provided to seal the enclosure.

Beam 14 travels out of the housing through laser portal 92. Likewise, camera field of view 36 travels out through camera portal 90. Because the scanner may operate in dusty or otherwise hostile environments, the portals are preferably covered by transparent plates. Once the housing is sealed, the entire scanner assembly is typically placed on a hard mounting point adjacent to the scanning area (such as next to a log conveyor). Thus, the reader will understand that the assembly shown in FIG. 20 is a self-contained unit. It has electrical connections (for power and data) as well as mechanical connections (for mounting). As these electrical and mechanical connections are conventional, they have not been illustrated. Likewise, those skilled in the art will know that the housing would typically contain PC boards, power supplies, wiring, etc.

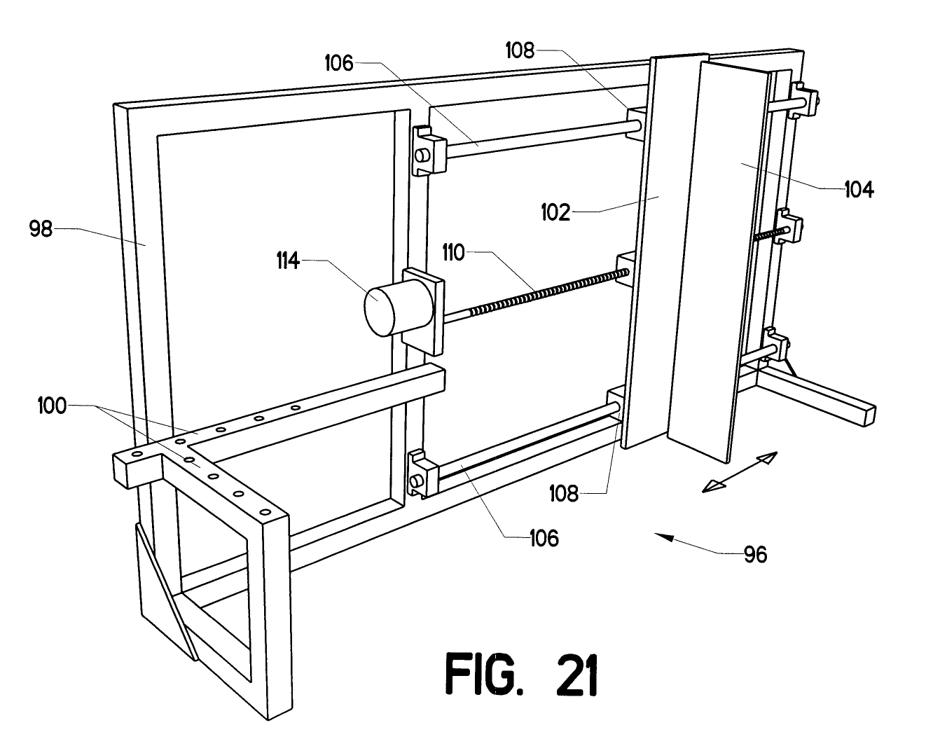

FIG. 21 discloses calibration machine 96, which is a fixture designed to implement the present inventive process. Chassis 98 is rigid metal frame. Scanner mount 100 is located on one end. The other end mounts a moving carriage 102. Carriage 102 mounts target surface 104, which serves as a target for a scanner being calibrated.

Carriage 102 includes two bearings 108 and a screw receiver 112. The bearings 108 ride back and forth on two guide rods 106. Screw receiver 112 interfaces with screw drive 110. Screw drive 110, in turn, is driven by drive motor 114. Thus, the reader will realize that when drive motor 114 turns screw drive 110, carriage 102 is propelled back and forth along guide rods 106.

Using a digital stepper motor, a highly accurate linear position sensor, or other known motion control means, the position of carriage 102 can be automatically and very accurately determined with respect to scanner mount 100. Thus, the location of target surface 104 can be very accurately determined with respect to scanner mount 100.

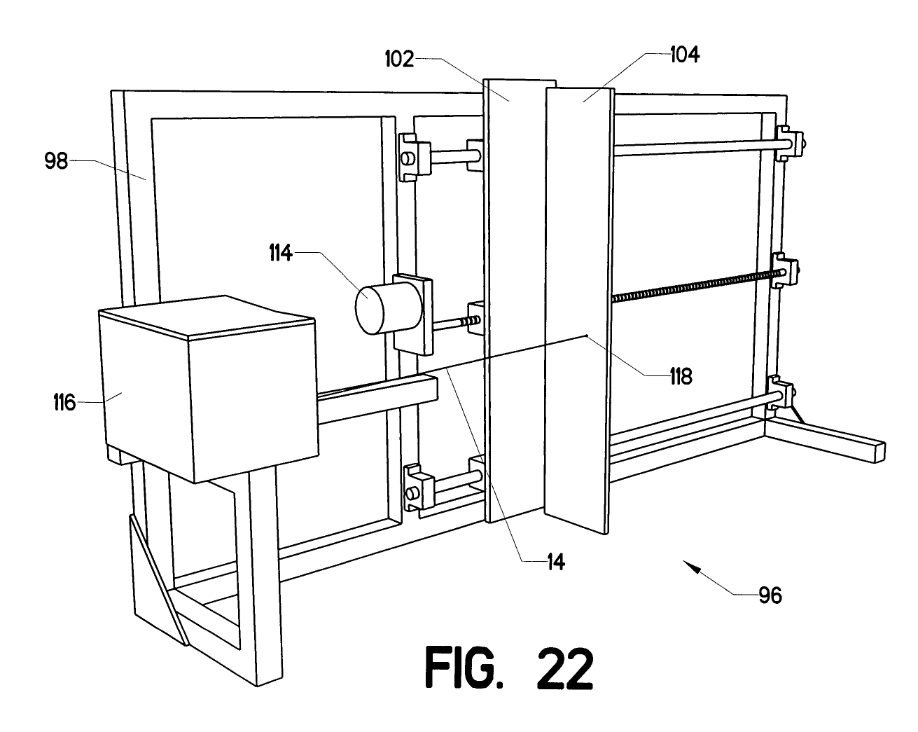

FIG. 22 shows scanner assembly 116 mounted on calibration machine 96. It should be rigidly mounted, using bolts or other fastening means. The calibration process is started by moving carriage 102 close to the scanner. The mirror is set to the zero degree position. The laser is then energized, producing beam 14 and impact point 118 on target surface 104. The position of the impact point within the view of the line scan camera is recorded. It is cross-referenced to the known distance from the scanner to the target surface (“known” through the use of the precise motion control means on the calibration machine).

The output from a line scan camera configured for these purposes is typically a number. As an example, a line scan camera having 4096 pixels would output a number between 0 and 4096. Typically, the edge portions of the pixel array may be unusable. Thus, a realistic output might be from 12 to 4084. Thus, an output corresponding to the closest position for the target surface might be 12.

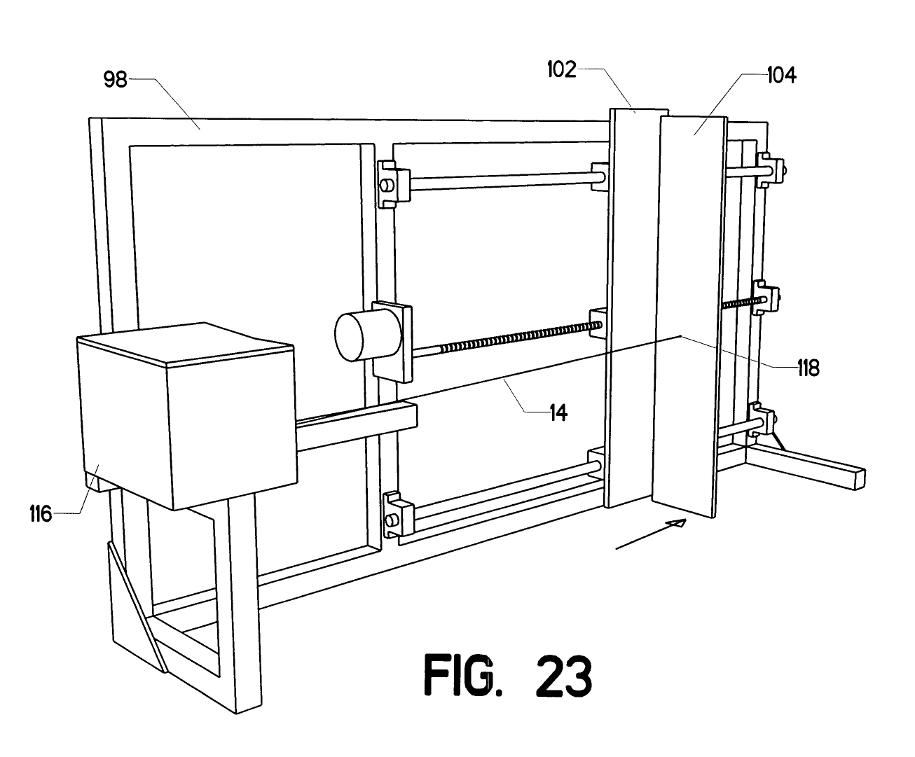

The carriage is then moved to a new position and a new reading for the line scan camera is recorded. This process is repeated at fixed intervals. Experimentation has shown that moving the carriage in one inch increments produces sufficient accuracy. FIG. 23 shows carriage 102 after it has been moved a little over half its range of travel. The reader will observe that the position of impact point 118 has shifted to the left on target surface 104, as the result of the parallax effect discussed previously (Comparing FIGS. 22 and 23 reveals this leftward shift). Thus, for the carriage position shown in FIG. 23, the line scan camera output would be 2460.

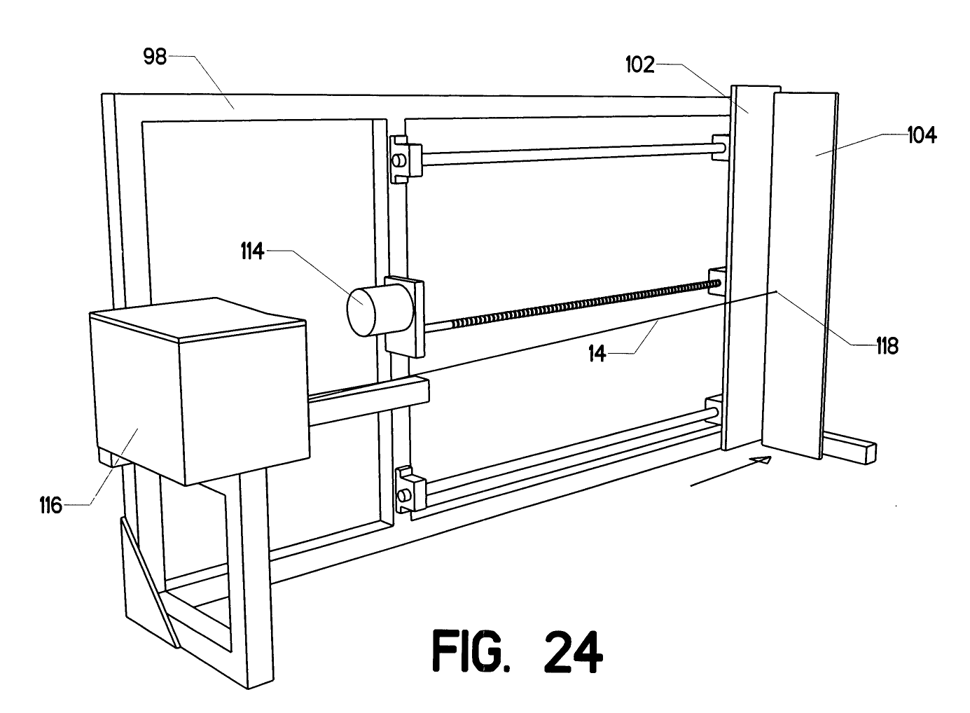

The process is continued in one inch steps until the carriage reaches the position shown in FIG. 24. Impact point 118 has shifted still further left. The output of the line scan camera has now reached its upper extreme of 4084.

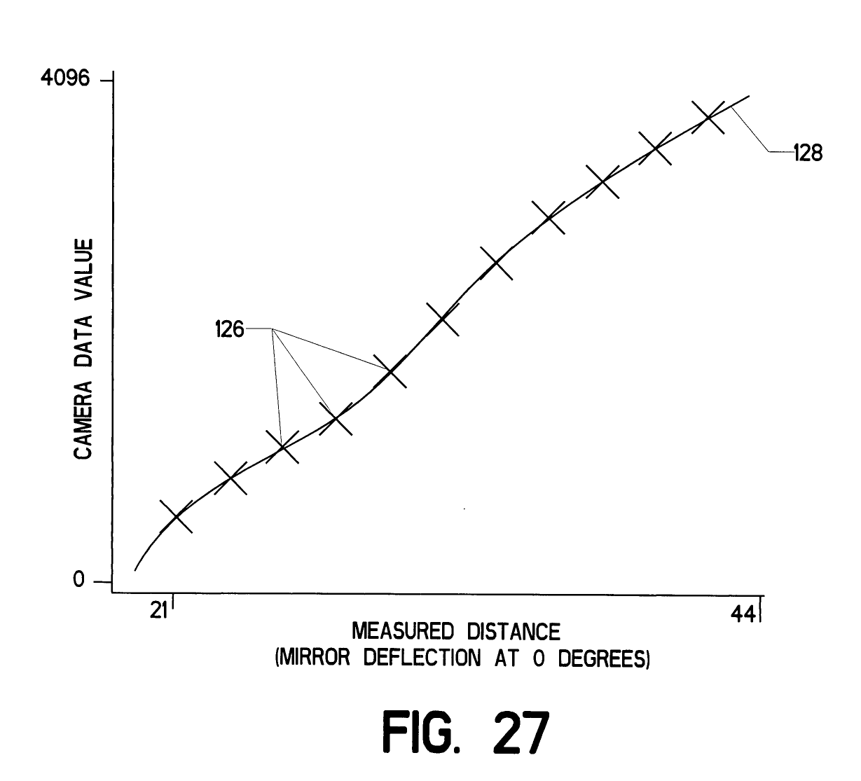

Those skilled in the art will therefore realize that the output of line scan camera can be correlated against the known position of target surface 104. The two values can be used to create an X-Y plot, as shown in FIG. 27. The X-axis shows the true distance from the center of oscillating shaft 30 in the scanner (a convenient origin point for a coordinate system) to target surface 104. The Y-axis shows the numerical output from the line scan camera. Each sample point is designated as a data point 126.

For the zero mirror deflection position, the plot shown in FIG. 27 should be perfectly linear. There should be no optical distortion at the zero mirror deflection point, and the parallax effect should create a straight line in the plot. In fact, if equations are written to solve the optical vectors, these equations will predict a linear plot. However, the reader will observe that the plot is not linear. Errors introduced by imperfections in the optics (mirrors and camera lenses) as well as the mounting hardware for the laser and the optics distort the linear curve. Thus, if the equations describing the optics are used to transform the raw camera data into position data, significant error will result.

The present invention avoids this problem by using a curve fit through the actual measured data. Those skilled in the art will know that many curve fits could be used. A simple least-squares method could be fitted through the points. Such a fit would be somewhat inaccurate, though. While it could reduce the error compared to using the optical equations, it cannot accommodate the “wavy” fluctuations seen in the plot. For this reason, a higher-order polynomial curve fit is preferred.

Polynomials of different order can be used. Higher orders tend to produce greater accuracy, though at some sacrifice of computational speed. Experimentation has shown that a fourth order polynomial gives excellent results. This would be an expression taking the form:

f(x)=A₀+A₁·x¹+A₂·x²+A₃·x³+A₄·x⁴

In this expression, “X” stands for the raw output from the line scan camera, and “f(x)” stands for the computed distance to the target surface. The reader will appreciate that once the coefficients are calculated, they remain constant for that particular scanner. Thus, the equation can be solved in a single step, meaning that computation speeds are very high. The results produced are also quite accurate, since the equation accounts for all the manufacturing tolerances present in the actual scanner being calibrated. FIG. 27 shows this curve as polynomial curve fit 128.

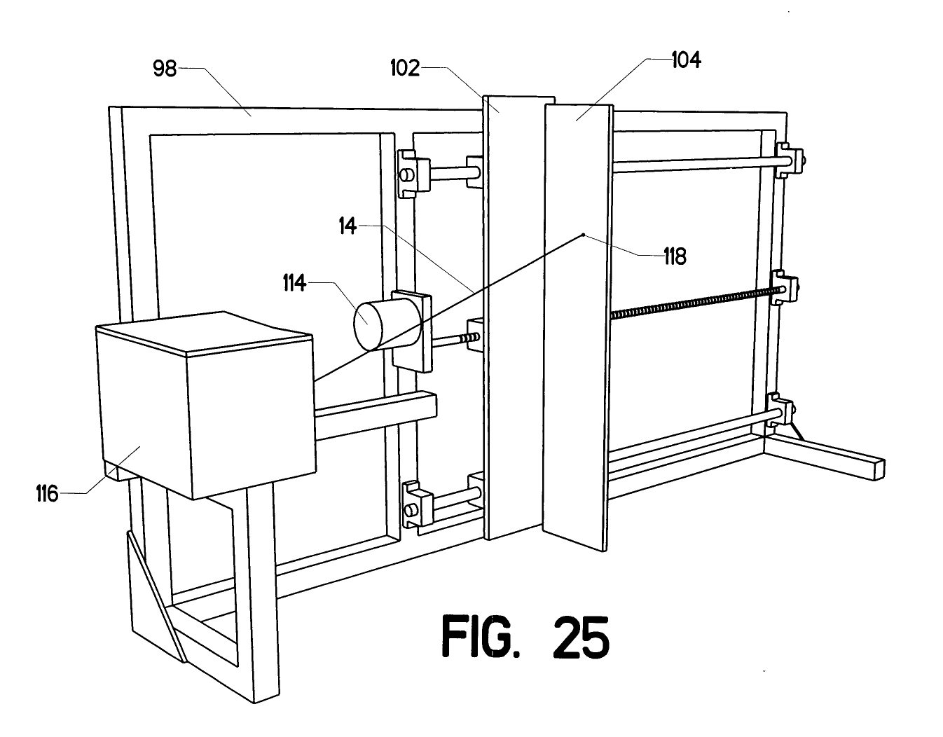

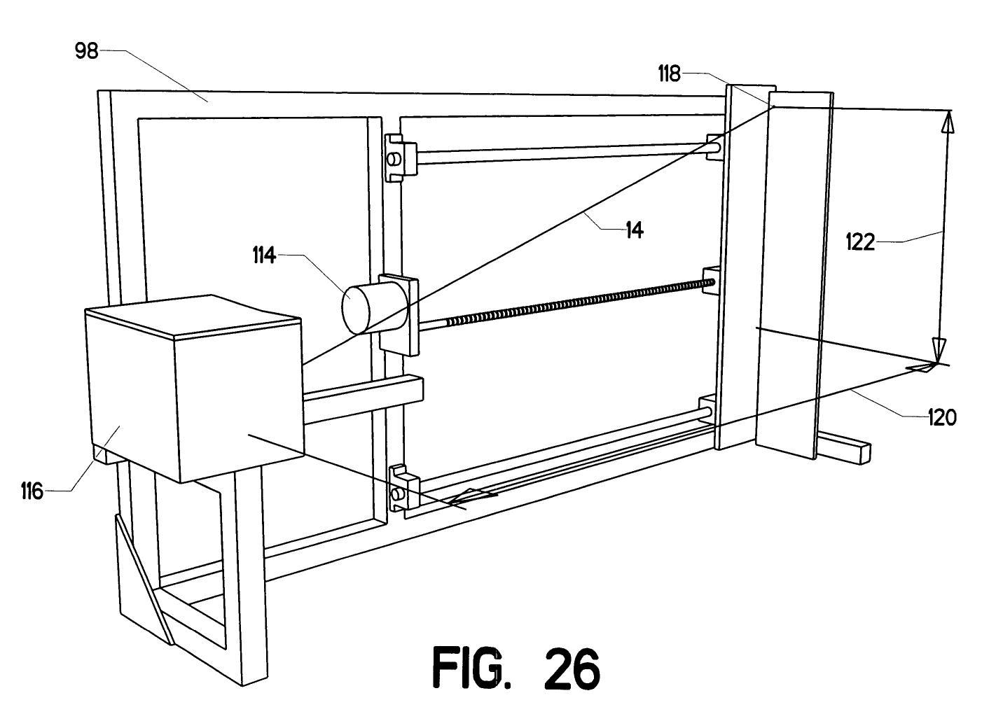

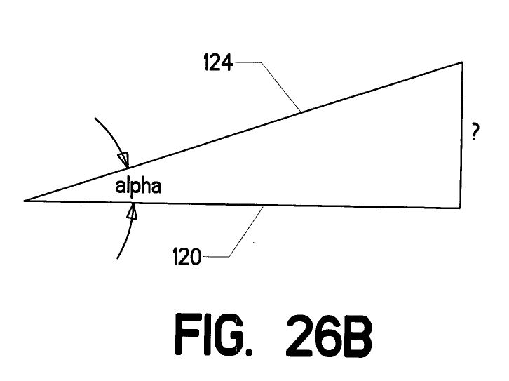

Of course, this equation only holds for the zero mirror deflection position. Since the scanner described previously deflects the mirror over a wide arc, other steps are needed. One approach is to simply perform the process described above for a variety of mirror deflections. FIG. 25 shows the calibration machine with the mirror set to +7.5 degrees, resulting in an upward beam deflection of +15 degrees. The reader will observe how impact point 118 has shifted upward on target surface 104. A set of measurements can be taken as the carriage is moved incrementally away from the scanner. FIG. 26 shows the same mirror position, after the carriage has traveled to the far extreme of its travel. Impact point 118 has shifted to the left, owing to the parallax effect.

In order to measure the exact distance to the impact point, the measuring equipment used must be able to measure both horizontal distance 120 and vertical distance 122 (Using any convenient coordinate system. In this case, one centered on oscillating shaft 30 in the scanner). The actual distance to the impact point can then be calculated using simple trigonometry. A series of such measurements are taken, and a plot is then made such as the one shown in FIG. 27 (An actual “plot” may never be made, but the curve fitting techniques the plot illustrates will be made). A fourth order polynomial is then created for the +7.5 degree mirror position.

The same process can be used for different mirror positions. As one example, polynomials could be created for the following mirror positions: −7.5, −6.0, −4.5, −3.0, −1.5, 0.0, +1.5, +3.0, +4.5, +6.0, and +7.5. This option would produce a set of 11 polynomials.

In use, the scanner might only use data from those 11 mirror positions. If more surface detail is desired, however, the scanner must use data from in between these mirror positions. Interpolation techniques can then be applied. An example using simple linear interpolation would be as follows:

(1) The actual mirror position is +0.3 degrees;

(2) The software determines that this position lies between the 0.0 and +1.5 degree positions;

(3) The software solves the polynomial for the 0.0 position and the polynomial for the +1.5 degree position; and

(4) The software then applies linear interpolation to the two answers from the two polynomials, to determine a solution for the +0.3 position.

Obviously, numerous other interpolation techniques could be applied.

Simplifications of the process are possible without introducing significant error. Returning to FIG. 26, the reader will recall that values for horizontal distance 14 and for vertical distance 122 must be known in order to calculate the distance to the target surface with maximum accuracy. Horizontal distance 120 can be easily determined from the linear motion control system driving the carriage. The vertical distance is more difficult to determine, however. In fact, the step of determining the vertical distance can be omitted. If the horizontal distance is known, and if the angle of mirror deflection is assumed to be accurate, the distance to the target can be computed.

FIG. 26B shows this simple trigonometry. Horizontal distance 120 is known. The angle of the mirror (and therefore the angle of the camera view to the target—shown as alpha) is assumed to be completely accurate. This value is known from the output of the galvanometer driving the mirror. Thus, calculated beam length 124 can be found. Of course, some errors in the mirror position will occur. Experimentation has shown, however, that these errors can be safely ignored. Thus, in actual practice, the distance to target for the mirror deflection shown in FIG. 26 can be determined while only knowing the galvanometer output (mirror angle) and horizontal distance 120.

Experimentation has also shown that a whole set of polynomials need not be developed. One can, in fact, develop only a single polynomial for the 0.0 degree mirror position. A table of error corrections can then be used to account for errors when the mirror is deflected.

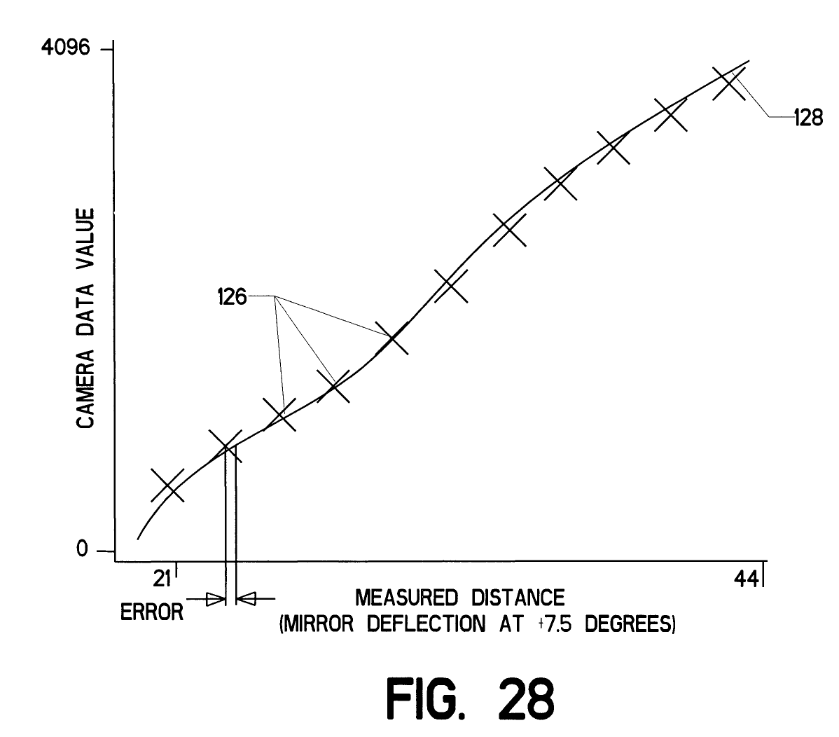

The error must be determined for a variety of mirror positions. The +7.5 degree position is shown in FIGS. 25 and 26. A series of actual distance measurements are made for this mirror position (using both measured horizontal and vertical distances, or using only measured horizontal distances and the simplification shown in FIG. 26B). These positions will be known as “calibrated linear positions.” If the measured distances for each of these calibrated linear positions are compared to the polynomial created for the 0.0 degree position, a plot such as shown in FIG. 28 results.

The reader will observe that data points 126 do not lie on polynomial curve fit 128. Most of the points lie some distance off the curve. This distance represents an error, as shown in the view. This error should be corrected. A correction value can easily be calculated for each of the data points. If the range to target varies between 21 and 44 inches, a table of correction values for the +7.5 degree mirror position might read as follows:

| | | | | | | | | | |
|---|---|---|---|---|---|---|---|---|---|
| Target Distance | 21 | 22 | 23 | 24 | 25 | 26 | 27 | 28 | . . . |
| Correction | −.016 | −.014 | −.012 | −.011 | −.010 | −.010 | −.009 | −.010 | . . . |

A similar table can be created for each mirror position. Preferably, a few sample mirror positions can be evaluated (as described previously). These positions will be known as “calibrated angular positions.” Combining the calibrated linear positions and the calibrated angular positions can then produce a correction matrix, a portion of which would look something like the following:

| | | Target Distance | | | | | | | |
|---|---|---|---|---|---|---|---|---|---|
| | | 21 | 22 | 23 | 24 | 25 | 26 | 27 | 28 |
| Mirror | +7.5 | −.016 | −.014 | −.012 | −.011 | −.010 | −.010 | −.009 | −.010 |
| Position | +6.0 | −.013 | −.012 | −.011 | −.010 | −.009 | −.008 | −.009 | −.009 |
| | +4.5 | −.010 | −.009 | −.009 | −.008 | −.008 | −.008 | −.008 | −.009 |
| | +3.0 | −.006 | −.005 | −.005 | −.005 | −.004 | −.004 | −.004 | −.004 |
| | +1.5 | −.002 | −.002 | −.002 | −.002 | −.001 | −.001 | −.001 | −.001 |
| | 0.0 | 0.0 | 0.0 | 0.0 | 0.0 | 0.0 | 0.0 | 0.0 | 0.0 |

In applying the correction matrix, one can simply use the nearest point. Intermediate mirror or distance positions can also be determined by interpolating points within the matrix. Simple linear interpolation can be used. Higher order interpolation can also be used, by considering three or more adjacent points within the matrix. An example of linear interpolation would go as follows: Assume that the galvanometer output shows +6.75 degrees. Further assume that when the fourth order polynomial is solved, it produces an initial calculated distance of 21.500 inches. The relevant part of the error correction matrix looks as follows:

Target Distance

| Mirror Position | 21 | 22 |
|---|---|---|
| +7.5 | −.016 | −.014 |
| +6.0 | −.013 | −.012 |

Linear interpolation between −0.016 and −0.013 for +6.75 degrees (which is exactly between the two calibrated positions) produces −0.0145. Linear interpolation between −0.014 and −0.012 produces −0.013. Interpolating for 21.5 (which lies halfway between 21 and 22) then involves interpolating between −0.0145 and −0.013, producing a result of −0.01375. This figure then becomes the appropriate correction value. This is obviously but one approach among many.

Summarizing, the reader will observe that several calibration techniques can be applied using the equipment and processes disclosed. These include:

1. Creating a set of fourth-order polynomials, where one polynomial is present for each calibrated mirror position. Interpolation is then used for intermediate mirror positions;

2. Creating a single fourth-order polynomial for the 0.0 mirror position. A matrix of error correction values are then created for other calibrated mirror positions. Interpolation techniques are used for intermediate mirror positions; and

3. Reasonably accurate distance values can be derived by only knowing the carriage position on the calibration machine and the angular position of the mirror.

Although the preceding description contains significant detail, it should not be construed as limiting the scope of the invention but rather as providing illustrations of the preferred embodiments of the invention. Thus, the scope of the invention should be fixed by the following claims, rather than by the examples given.

Having described our invention, we claim:

1. In a scanner for determining a range to a target object which lies between a minimum range and a maximum range, wherein said scanner includes a rotatable scanning mirror capable of assuming a neutral position, a maximum positive angular displacement from said neutral position, a maximum negative angular displacement from said neutral position, and a plurality of other positions therebetween, and wherein said scanning mirror provides a plurality of scanning mirror data values corresponding to said angular displacement of said scanning mirror, a laser beam directed toward said scanning mirror and from thence out toward said target object in order to form an impact point on said target object, and a camera directed toward said scanning mirror so that a field of view of said camera is directed out toward said target object, so that said laser beam and said field of view of said camera are swept across said target object in synchronization, and wherein said camera provides a plurality of camera data values corresponding to a plurality of locations of said impact point within said field of view of said camera, with one camera data value corresponding to each particular location of said impact point within said field of view of said camera, a method for converting each of said camera data values to a distance from said scanner to said target object, comprising:
a. providing a polynomial equation which accurately solves for said distance from said scanner to said target object when said scanning mirror is in said neutral position;
b. providing an error correction matrix, including
i. a plurality of calibrated angular positions for said rotatable scanning mirror in the range between said minimum and maximum angular displacements, inclusive of said minimum and maximum angular displacements;
ii. a plurality of calibrated linear positions for said scanner in the range between said minimum range and said maximum range;
iii. for each of said plurality of calibrated angular positions and said calibrated linear positions, an error correction value;
c. entering a specific camera data value into said polynomial and solving said polynomial in order to determine an initial calculated distance from said scanner to said target;
d. comparing said initial calculated value against said error correction matrix, using the nearest of said calibrated linear positions in said matrix to said initial calculated distance and the nearest of said calibrated angular positions in said matrix to said angular displacement of said scanning mirror, in order to determine an appropriate error correction value; and
e. adding said appropriate error correction value to said initial calculated distance in order to determine a corrected calculated distance.

2. A method as recited in claim 1, wherein interpolation is used in applying said error correction matrix.

3. A method as recited in claim 1, wherein said polynomial equation is a third order polynomial equation.

4. A method as recited in claim 1, wherein said polynomial equation is a fourth order polynomial equation.

5. A method as recited in claim 2, wherein said interpolation is linear interpolation.

6. In a scanner for determining a range to a target object which lies between a minimum range and a maximum range, wherein said scanner includes a rotatable scanning mirror capable of assuming a neutral position, a maximum positive angular displacement from said neutral position, a maximum negative angular displacement from said neutral position, and a plurality of other positions therebetween, and wherein said scanning mirror provides a plurality of scanning mirror data values corresponding to said angular displacement of said scanning mirror, a laser beam directed toward said scanning mirror and from thence out toward said target object in order to form an impact point on said target object, and a camera directed toward said scanning mirror so that a field of view of said camera is directed out toward said target object, so that said laser beam and said field of view of said camera are swept across said target object in synchronization, and wherein said camera provides a plurality of camera data values corresponding to a plurality of locations of said impact point within said field of view of said camera, with one camera data value corresponding to each particular location of said impact point within said field of view of said camera, a method for converting each of said camera data values to a distance from said scanner to said target object, comprising:
a. selecting a plurality of calibrated angular positions for said rotatable scanning mirror in the range between said minimum and maximum angular displacements, inclusive of said minimum and maximum angular displacements;
b. for each of said plurality of calibrated angular positions providing a polynomial equation which accurately solves for said distance from said scanner to said target object; and
c. entering a specific camera data value into one of said polynomials, wherein said one of said polynomials corresponds to the calibrated angular position which is nearest to said angular displacement of said scanning mirror in order to determine a distance from said scanner to said target.

7. A method as recited in claim 6, wherein said polynomial equations are third order polynomial equations.

8. A method as recited in claim 6, wherein said polynomial equations are fourth order polynomial equations.

9. In a scanner for determining a range to a target object which lies between a minimum range and a maximum range, wherein said scanner includes a rotatable scanning mirror capable of assuming a neutral position, a maximum positive angular displacement from said neutral position, a maximum negative angular displacement from said neutral position, and a plurality of other positions therebetween, and wherein said scanning mirror provides a plurality of scanning mirror data values corresponding to said angular displacement of said scanning mirror, a laser beam directed toward said scanning mirror and from thence out toward said target object in order to form an impact point on said target object, and a camera directed toward said scanning mirror so that a field of view of said camera is directed out toward said target object, so that said laser beam and said field of view of said camera are swept across said target object in synchronization, and wherein said camera provides a plurality of camera data values corresponding to a plurality of locations of said impact point within said field of view of said camera, with one camera data value corresponding to each particular location of said impact point within said field of view of said camera, a method for converting each of said camera data values to a distance from said scanner to said target object, comprising:
a. selecting a plurality of calibrated angular positions for said rotatable scanning mirror in the range between said minimum and maximum angular displacements, inclusive of said minimum and maximum angular displacements;
b. for each of said plurality of calibrated angular positions providing a polynomial equation which accurately solves for said distance from said scanner to said target object;
c. entering a specific camera data value into a first one of said polynomials, wherein said first one of said polynomials corresponds to the calibrated angular position which is proximate to but less than said angular displacement of said scanning mirror in order to determine a first calculated distance from said scanner to said target;
d. entering a specific camera data value into a second one of said polynomials, wherein said second one of said polynomials corresponds to the calibrated angular position which is proximate to but greater than said angular displacement of said scanning mirror in order to determine a second calculated distance from said scanner to said target; and
e. interpolating between said first and second calculated distances to obtain an interpolated calculated distance.

10. A method as recited in claim 9, wherein said polynomials are third order polynomials

11. A method as recited in claim 10, wherein said polynomials are fourth order polynomials.

12. In a scanner for determining a range to a target object which lies between a minimum range and a maximum range, wherein said scanner includes a rotatable scanning mirror capable of assuming a neutral position, a maximum positive angular displacement from said neutral position, a maximum negative angular displacement from said neutral position, and a plurality of other positions therebetween, and wherein said scanning mirror provides a plurality of scanning mirror data values corresponding to said angular displacement of said scanning mirror, a laser beam directed toward said scanning mirror and from thence out toward said target object in order to form an impact point on said target object, and a camera directed toward said scanning mirror so that a field of view of said camera is directed out toward said target object, so that said laser beam and said field of view of said camera are swept across said target object in synchronization, and wherein said camera provides a plurality of camera data values corresponding to a plurality of locations of said impact point within said field of view of said camera, with one camera data value corresponding to each particular location of said impact point within said field of view of said camera, a method for calibrating said scanner, comprising:
a. determining a polynomial equation which accurately solves for a distance from said scanner to said target object when said scanning mirror is in said neutral position by
i. providing a target surface at a known distance from said scanner;
ii. correlating said known distance against a camera data value corresponding to said known distance;
iii. moving said target surface through a series of such known distances and collecting a camera data value corresponding to each of said known distances in order to create a correlation between said camera data values and said known distances;
iv. fitting said polynomial through said correlation between said camera data values and said known distances;
b. determining an error correction matrix, including
i. a plurality of calibrated angular positions for said rotatable scanning mirror in the range between said minimum and maximum angular displacements, inclusive of said minimum and maximum angular displacements;
ii. a plurality of calibrated linear positions for said scanner in the range between said minimum range and said maximum range;
iii. for each of said plurality of calibrated angular positions and said calibrated linear positions, an error correction value;
c. wherein said polynomial can then be used to solve for an initial calculated distance for a specific camera data value;
d. wherein an appropriate error correction value can be selected using the nearest of said calibrated linear positions in said matrix to said initial calculated distance and the nearest of said calibrated angular positions in said matrix to said angular displacement of said scanning mirror, in order to determine an appropriate error correction value; and
e. wherein said appropriate error correction value can be added to said initial calculated distance in order to determine a corrected calculated distance.

13. A method as recited in claim 12, wherein interpolation is used in applying said error correction matrix.

14. A method as recited in claim 12, wherein said polynomial equation is a third order polynomial equation.

15. A method as recited in claim 12, wherein said polynomial equation is a fourth order polynomial equation.

16. A method as recited in claim 13, wherein said interpolation is linear interpolation.
